(19) United States
(12) Patent Application Publication
(10) Pub. No.: US 2024/0378506 A1
(43) Pub. Date: Nov. 14, 2024

(54) Zero-Touch Deployment and Orchestration of Network Intelligence in Open RAN Systems

(71) Applicant: Northeastern University, Boston, MA (US)

(72) Inventors: Salvatore D'ORO, Brookline, MA (US); Tommaso MELODIA, Newton, MA (US); Leonardo BONATI, Boston, MA (US); Michele POLESE, Cambridge, MA (US)

(21) Appl. No.: 18/685,053

(22) PCT Filed: Aug. 25, 2022
(86) PCT No.: PCT/US2022/041547

§ 371 Date: Feb. 20, 2024

Related U.S. Application Data
(60) Provisional application No. 63/237,057, filed on Aug. 25, 2021.

(51) Int. Cl. G06N 20/00

(52) U.S. Cl. CPC G06N 20/00

(57) ABSTRACT

Provided herein are methods and systems for deployment and orchestration of network intelligence in an Open RAN including receiving requests at a request collector, selecting one, by an orchestration engine, or more ML/Al models applicable for satisfying the plurality of collected requests, assigning at least one Open RAN resource to execute each of the ML/Al models, automatically generating, by an orchestration engine, executable software components embedding at least one of the ML/Al models, dispatching each executable software component to the assigned Open RAN resource, and instantiating, at the Open RAN resource, at least one of the ML/AI models embedded in the executable software component to configure the Open RAN to satisfy the requests.

### CROSS REFERENCE TO RELATED APPLICATIONS

This application claims benefit under 35 U.S.C. § 119 (e) of U.S. Provisional Application No. 63/237,057, filed on 25 Aug. 2022, entitled “Zero-Touch Deployment and Orchestration of Network Intelligence in Open RAN Systems,” the entirety of which is incorporated by reference herein.

### STATEMENT REGARDING FEDERALLY SPONSORED RESEARCH OR DEVELOPMENT

This invention was made with government support under Grant Nos.: N00014-19-1-2409 and ONR N00014-20-1-2132 awarded by the Office of Naval Research and under Grant Nos.: CNS-1923789 and NSF CNS-1925601 awarded by the U.S. National Science Foundation. The government has certain rights in the invention.

### BACKGROUND

The fifth-generation (5G) of cellular networks and its evolution (NextG), will mark the end of the era of inflexible hardware-based Radio Access Network (RAN) architectures in favor of innovative and agile solutions built upon softwarization, openness and disaggregation principles. This paradigm shift—often referred to as Open RAN—comes with unprecedented flexibility. It makes it possible to split network functionalities—traditionally embedded and executed in monolithic base stations—and instantiate and control them across multiple nodes of the network. In this context, the O-RAN Alliance, a consortium led by Telecommunications Companies (Telcos), vendors and academic partners, is developing a standardized architecture for Open RAN that promotes horizontal disaggregation and standardization of RAN interfaces, thus enabling multi-vendor equipment interoperability and algorithmic network control and analytics. However, while O-RAN is a clear leader in standardizing the Open RAN architecture, it should also be noted that other organizations such as, for example, the Telecom Infra Project (TIP), are also working in this area and that Open RAN solutions can preferably be operative with any Open RAN architecture.

O-RAN embraces the 3rd Generation Partnership Project (3GPP) functional split with Central Units (CUs), Distributed Units (DUs) and Radio Units (RUs) implementing different functions of the protocol stack. O-RAN also introduces (i) a set of open standardized interfaces to interact, control and collect data from every node of the network; as well as (ii) RAN Intelligent Controllers (RICs) that execute third-party applications over an abstract overlay to control RAN functionalities, i.e., xApps in the near-Realtime (RT) and rApps in the non-RT RIC. The O-RAN architecture makes it possible to bring automation and intelligence to the network through Machine Learning (ML) and Artificial Intelligence (AI), which will leverage the enormous amount of data generated by the RAN—and exposed through the O-RAN interfaces—to analyze the current network conditions, forecast future traffic profiles and demand, and implement closed-loop network control strategies to optimize the RAN performance. For this reason, how to design, train and deploy reliable and effective data-driven solutions has recently received increasing interest from academia and industry alike, with applications ranging from controlling RAN resource and transmission policies, to forecasting and classifying traffic and Key Performance Indicators (KPIs), thus highlighting how these approaches will be foundational to the Open RAN paradigm. However, how to deploy and manage, i.e., orchestrate, intelligence into softwarized cellular networks is by no means a solved problem for the following reasons:

Complying with Time Scales and Making Input Available:

Adapting RAN parameters and functionalities requires control loops operating over time scales ranging from a few milliseconds (i.e., real-time) to a few hundreds of milliseconds (i.e., near-RT) to several seconds (i.e., non-RT). As a consequence, the models and the location where they are executed need to be selected to be able to retrieve the necessary inputs and compute the output within the appropriate time constraints. For instance, while IQ samples are easily available in real time at the RAN, it is extremely hard (if not impossible altogether) to make large amounts of IQ samples available at the near-RT and non-RT RICs within the same temporal window, making the execution of models that require IQ samples as input on the RICs ineffective.

### Choosing the Right Model to Accommodate Telco Requests:

Each ML/AI model is designed to accomplish specific inference and/or control tasks and requires well-defined inputs in terms of data type (e.g., IQ samples, throughput, mobility) and size. One must make sure that the most suitable model is selected for a specific Telco request, and that it meets the required performance metrics (e.g., minimum accuracy), delivers the desired inference/control functionalities, and is instantiated on nodes with enough resources to execute it.

For these reasons, orchestrating network intelligence in the Open RAN presents unprecedented and unique challenges.

Recently, the application of data-driven algorithms to cellular networks is gaining momentum as a promising and effective tool to design and deploy ML/AI solutions capable of predicting, controlling, and automating the network behavior under dynamic conditions. Relevant examples include the application of Deep Learning and Deep Reinforcement Learning (DRL) to predict the network load, classify traffic, perform beam alignment, allocate radio resources, and deploy service-tailored network slices. It is clear that data-driven optimization techniques will play a key role in the transition toward intelligent networks, especially in the O-RAN ecosystem.

However, a relevant challenge that still remains unsolved is how to bring such intelligence to the network in an efficient, reliable and automated way. For example:

Ayala-Romero et al. present an online Bayesian learning orchestration framework for intelligent virtualized RANs in which radio resources are allocated according to channel conditions and network load. The same authors present a similar framework where networking and computational resources are orchestrated via DRL to comply with service level agreements (SLAs) while accounting for the limited amount of RAN resources.

Singh et al. present GreenRAN, an energy-efficient orchestration framework for NextG systems that splits and allocates RAN components (e.g., DUs/CUs/RUs) according to the current resource availability.

Chatterjee et al. present a radio resource orchestration framework for 5G applications where network slices are dynamically re-assigned to avoid inefficiencies and SLA violations.

Morais et al. and Matoussi et. al. present frameworks to optimally disaggregate, place and orchestrate RAN components in the network to minimize computation and energy consumption while accounting for diverse latency and performance requirements.

However, although these works all present orchestration frameworks for NextG systems, they are focused on orchestrating RAN resources and functionalities, rather than network intelligence which, as discussed above, represents a substantially different problem.

In the context of orchestrating ML/AI models in NextG systems, Baranda et al. present an architecture for the automated deployment of models in the 5Growth management and orchestration (MANO) platform, and demonstrate automated instantiation of models on demand.

Salem et al. proposes an orchestrator to select and instantiate inference models at different locations of the network to obtain a desirable balance between accuracy and latency. However, Salem is not concerned with O-RAN systems, but focuses on data-driven solutions for inference in cloud-based applications, which represents a substantially different problem.

In addition to the shortcomings discussed above, none of the prior art discussed above attempts to instantiate both inference and control solutions complying with O-RAN specifications. Moreover, none of the prior art discussed above contemplates or permits model sharing across multiple requests to efficiently reuse available network resources.

### SUMMARY

Provided herein are methods and systems for zero-touch deployment and orchestration of network intelligence in Open RAN (“O-RAN”) systems which provide innovative, automated, and scalable solutions to these challenges, including automated intelligence orchestration framework for the O-RAN.

In one aspect, a method for deployment and orchestration of network intelligence in an open radio access network (Open RAN) is provided. The method includes receiving a plurality of requests at a request collector of an orchestration app executable via a service management and orchestration (SMO) framework installed at a non-real-time (non-RT) RAN intelligent controller (RIC) of the Open RAN, each request specifying a requested functionality, a requested location, and a requested timescale. The method also includes selecting, by an orchestration engine, one or more pre-trained machine learning and/or artificial intelligence (ML/AI) models stored in a ML/AI catalog of the orchestration app, the selected ML/AI models applicable for satisfying the plurality of collected requests. The method also includes assigning at least one resource of the Open RAN to execute each of the applicable ML/AI models according to an orchestration policy determined by the orchestration engine, the Open RAN resources including at least one of the non-RT RIC, a near-real-time (near-RT) RIC, a centralized unit (CU), a distributed unit (DU), and a radio unit (RU). The method also includes automatically generating, by the orchestration engine, a plurality of executable software components, each executable software component embedding at least one of the ML/AI models and configured to be executed by the assigned one of the Open RAN resources. The method also includes dispatching each executable software component to the assigned one of the Open RAN resources. The method also includes instantiating, at each of the assigned Open RAN resources, the at least one of the ML/AI models embedded within a corresponding one of the dispatched executable software components to configure the Open RAN to satisfy the requests.

In some embodiments, the steps of selecting and assigning are performed by an optimization core of the orchestration engine. In some embodiments, the step of dispatching is performed by an instantiation and orchestration module of the orchestration engine. In some embodiments, the step of automatically generating is performed by a container creation module of the orchestration engine. In some embodiments, the executable software components include O-RAN docker containers comprising at least one of an rApp executable at the non-RT RIC, an xApp executable at the near-RT RIC, and a dApp executable at one or more of the CU, the DU, and the RU. In some embodiments, the step of assigning further comprises accessing an infrastructure abstraction module of the orchestration app to determine a type and network location of the Open RAN resources. In some embodiments, determining the orchestration policy further comprises solving a binary integer linear programming (BILP) orchestration problem. In some embodiments, determining the orchestration policy further comprises reducing a complexity of the BILP orchestration problem by at least one of function-aware pruning, architecture-aware pruning, and graph tree branching.

In another aspect, a system for deployment and orchestration of network intelligence in an open radio access network (Open RAN) is provided. The system includes an Open RAN having a plurality of Open RAN resources including at least one of a non-real-time (non-RT) RAN intelligent controller (RIC), a near-real-time (near-RT) RIC, a centralized unit (CU), a distributed unit (DU), and a radio unit (RU). The system also includes an orchestration app executable via a service management and orchestration (SMO) framework installed at the non-RT RIC. The orchestration app includes a request collector configured to receive a plurality of requests, each request specifying a requested functionality, a requested location, and a requested timescale. The orchestration app also includes an orchestration engine. The orchestration engine is configured to select one or more pre-trained machine learning and/or artificial intelligence (ML/AI) models stored in a ML/AI catalog of the orchestration app, the selected ML/AI models applicable for satisfying the plurality of collected requests. The orchestration engine is also configured to assign, according to an orchestration policy determined by the orchestration engine, at least one of the Open RAN resources to execute each of the applicable ML/AI models. The orchestration engine is also configured to generate a plurality of executable software components, each executable software component embedding at least one of the ML/AI models and configured to be executed by the assigned one of the Open RAN resources. The orchestration engine is also configured to dispatch each executable software component to the assigned one of the Open RAN resources. Each of the assigned Open RAN resources is configured to instantiate the at least one of the ML/AI models embedded within a corresponding one of the dispatched executable software components to configure the Open RAN to satisfy the requests.

In some embodiments, the orchestration engine also includes an optimization core configured to select the ML/AI models and assign the Open RAN resources to execute the selected ML/AI models. In some embodiments, the orchestration engine also includes an instantiation and orchestration module configured to dispatch the executable software components. In some embodiments, the orchestration engine also includes a container creation module configured to generate the plurality of executable software components. In some embodiments, the executable software components include O-RAN docker containers comprising at least one of an rApp executable at the non-RT RIC, an xApp executable at the near-RT RIC, and a dApp executable at one or more of the CU, the DU, and the RU. In some embodiments, each dApp includes at least one RT-Transmission Time Interval (RT-TTI) level control loop. In some embodiments, the RT-TTI level control loop of each dApp operates on a timescale of 10 ms or less. In some embodiments, the orchestration app further comprises an infrastructure abstraction module accessible by the orchestration engine to determine a type and network location of the Open RAN resources. In some embodiments, the orchestration policy is determined according to a solution of a binary integer linear programming (BILP) orchestration problem. In some embodiments, the orchestration policy is further determined according to at least one preprocessing solution of at least one of function-aware pruning, architecture-aware pruning, and graph tree branching.

Additional features and aspects of the technology include the following:

1.A method for deployment and orchestration of network intelligence in an open radio access network (Open RAN) comprising:
receiving a plurality of requests at a request collector of an orchestration app executable via a service management and orchestration (SMO) framework installed at a non-real-time (non-RT) RAN intelligent controller (RIC) of the Open RAN, each request specifying a requested functionality, a requested location, and a requested timescale;
selecting, by an orchestration engine, one or more pre-trained machine learning and/or artificial intelligence (ML/AI) models stored in a ML/AI catalog of the orchestration app, the selected ML/AI models applicable for satisfying the plurality of collected requests;
assigning at least one resource of the Open RAN to execute each of the applicable ML/AI models according to an orchestration policy determined by the orchestration engine, the Open RAN resources including at least one of the non-RT RIC, a near-real-time (near-RT) RIC, a centralized unit (CU), a distributed unit (DU), and a radio unit (RU);
automatically generating, by the orchestration engine, a plurality of executable software components, each executable software component embedding at least one of the ML/AI models and configured to be executed by the assigned one of the Open RAN resources;
dispatching each executable software component to the assigned one of the Open RAN resources; and
instantiating, at each of the assigned Open RAN resources, the at least one of the ML/AI models embedded within a corresponding one of the dispatched executable software components to configure the Open RAN to satisfy the requests.
   2. The method of feature 1, wherein the steps of selecting and assigning are performed by an optimization core of the orchestration engine.
   3. The method of any of features 1-2, wherein the step of dispatching is performed by an instantiation and orchestration module of the orchestration engine.
   4. The method of of any of features 1-3, wherein the step of automatically generating is performed by a container creation module of the orchestration engine.
   5. The method of of any of features 1-4, wherein the executable software components include O-RAN docker containers comprising at least one of an rApp executable at the non-RT RIC, an xApp executable at the near-RT RIC, and a dApp executable at one or more of the CU, the DU, and the RU.
   6. The method of of any of features 1-5, wherein the step of assigning further comprises accessing an infrastructure abstraction module of the orchestration app to determine a type and network location of the Open RAN resources.
   7 The method of of any of features 1-6, wherein determining the orchestration policy further comprises solving a binary integer linear programming (BILP) orchestration problem.
   8. The method of feature 7, wherein determining the orchestration policy further comprises reducing a complexity of the BILP orchestration problem by at least one of function-aware pruning, architecture-aware pruning, and graph tree branching.
   9. A system for deployment and orchestration of network intelligence in an open radio access network (Open RAN) comprising:
an Open RAN having a plurality of Open RAN resources including at least one of a non-real-time (non-RT) RAN intelligent controller (RIC), a near-real-time (near-RT) RIC, a centralized unit (CU), a distributed unit (DU), and a radio unit (RU);
an orchestration app executable via a service management and orchestration (SMO) framework installed at the non-RT RIC, the orchestration app including:
   a request collector configured to receive a plurality of requests, each request specifying a requested functionality, a requested location, and a requested timescale;
   an orchestration engine configured to:
      select one or more pre-trained machine learning and/or artificial intelligence (ML/AI) models stored in a ML/AI catalog of the orchestration app, the selected ML/AI models applicable for satisfying the plurality of collected requests,
      assign, according to an orchestration policy determined by the orchestration engine, at least one of the Open RAN resources to execute each of the applicable ML/AI models,
      generate a plurality of executable software components, each executable software component embedding at least one of the ML/AI models and configured to be executed by the assigned one of the Open RAN resources, and
      dispatch each executable software component to the assigned one of the Open RAN resources; and
each of the assigned Open RAN resources configured to instantiate the at least one of the ML/AI models embedded within a corresponding one of the dispatched executable software components to configure the Open RAN to satisfy the requests.
   10. The system of feature 9, wherein the orchestration engine further comprises an optimization core configured to select the ML/AI models and assign the Open RAN resources to execute the selected ML/AI models.
   11. The system of any of features 9-10, wherein the orchestration engine further comprises an instantiation and orchestration module configured to dispatch the executable software components.
   12. The system of any of features 9-11, wherein the orchestration engine further comprises a container creation module configured to generate the plurality of executable software components.
   13. The system of any of features 9-12, wherein the executable software components include O-RAN docker containers comprising at least one of an rApp executable at the non-RT RIC, an xApp executable at the near-RT RIC, and a dApp executable at one or more of the CU, the DU, and the RU.
   14. The system of feature 13, wherein each dApp includes at least one RT-Transmission Time Interval (RT-TTI) level control loop.
   15. The system of feature 14, wherein the RT-TTI level control loop of each dApp operates on a timescale of 10 ms or less.
   16. The system of any of features 9-15, wherein the orchestration app further comprises an infrastructure abstraction module accessible by the orchestration engine to determine a type and network location of the Open RAN resources.
   17. The system of any of features 9-16, wherein the orchestration policy is determined according to a solution of a binary integer linear programming (BILP) orchestration problem.
   18. The system of feature 17, wherein the orchestration policy is further determined according to at least one preprocessing solution of at least one of function-aware pruning, architecture-aware pruning, and graph tree branching.
   19. The system of feature 13, wherein at least one of the O-RAN containers is a dApp container executable at a DU.
   20. The system of feature 19, wherein the dApp container includes at least one southbound interface configured to receive waveform samples in a frequency domain from one or more RUs over an O-RAN fronthaul interface and transport blocks, or Radio Link Control (RLC) packets locally available at the DU.
   21. The system of feature 13, wherein at least one of the O-RAN containers is a dApp container executable at a CU.
   22. The system of feature 21, wherein the dApp container includes at least one southbound interface configured to perform inference on data pertaining to Packet Data Convergence Protocol (PDCP) and Service Data Adaptation Protocol (SDAP) locally available at the CU.

### DESCRIPTION OF THE DRAWINGS

FIG. 1A illustrates an O-RAN reference architecture and interfaces having OrchestRAN installed therein in accordance with various embodiments.

FIG. 1B illustrates an O-RAN network architecture having OrchestRAN installed therein represented as a tree graph in accordance with various embodiments.

FIG. 2 illustrates a System design of OrchestRAN and main procedures in accordance with various embodiments.

FIG. 3 illustrates an example of creation and dispatchment of an xApp on the near-RT RIC via OrchestRAN in accordance with various embodiments.

FIG. 4A illustrates an example of O-RAN without function outsourcing and model sharing in accordance with various embodiments.

FIG. 4B illustrates an example of O-RAN with function outsourcing and model sharing in accordance with various embodiments.

FIG. 5A illustrates a number of variables at different network sizes for different variable reduction methodologies in accordance with various embodiments.

FIG. 5B illustrates a computation time at different network sizes for different variable reduction methodologies in accordance with various embodiments.

FIG. 6A illustrates a ratio of accepted requests with model sharing but without branching in accordance with various embodiments.

FIG. 6B illustrates a ratio of partially accepted requests w/model sharing and branching in accordance with various embodiments.

FIG. 7A illustrates resource utilization with and without model sharing in accordance with various embodiments.

FIG. 7B illustrates resource saving with model sharing in accordance with various embodiments.

FIG. 8 illustrates a percentage of accepted requests without model sharing for different use cases in accordance with various embodiments.

FIG. 9 illustrates a distribution of model instantiation for different use cases in accordance with various embodiments.

FIG. 10 illustrates an OrchestRAN prototype architecture on Colosseum and integration with O-RAN and SCOPE components in accordance with various embodiments.

FIG. 11A illustrates a probability of instantiating O-RAN applications at the near-RT RIC in accordance with various embodiments.

FIG. 11B illustrates traffic over an O-RAN E2 interface for different configurations wherein dark bars represent traffic related to payload only in accordance with various embodiments.

FIG. 12A illustrates dynamic activation of O-RAN applications at near-RT RIC and DU 7 in accordance with various embodiments.

FIG. 12B illustrates a throughput performance comparison for different deployments of O-RAN applications and network slices wherein solid lines and dashed lines refer to traffic for UE1,i and UE2,i of Slice i in accordance with various embodiments.

FIG. 12C illustrates a buffer size performance comparison for different deployments of O-RAN applications and network slices wherein solid lines and dashed lines refer to traffic for UE1,i and UE2,i of Slice i in accordance with various embodiments.

FIG. 13 illustrates an O-RAN architecture, applications, and control loops, including dApps, in accordance with various embodiments.

FIG. 14 illustrates implementation of dApps, including an extension to the O-RAN architecture in accordance with various embodiments.

FIG. 15 illustrates data rate and latency for performing I/Q-based beam management over E2 interface, illustrating that, in most cases, latency is higher than 10 ms, which is the maximum latency for performing real-time beam management in accordance with various embodiments.

FIG. 16 illustrates an E2 traffic analysis for various dApp implementations in accordance with various embodiments.

FIG. 17 illustrates URLLC slice end-to-end latency for different RAN slicing and schedulers in accordance with various embodiments.

### DETAILED DESCRIPTION

As described in detail above, orchestrating network intelligence in the Open RAN presents unprecedented and unique challenges. Provided herein are methods and systems for zero-touch deployment and orchestration of network intelligence in Open RAN systems which provide innovative, automated, and scalable solutions to these challenges (hereinafter referred to as “OrchestRAN”). As described herein, OrchestRAN includes an automated intelligence orchestration framework for the Open RAN.

For convenience and ready understanding by persons of skill in the art, O-RAN nomenclature (e.g., xApp, rApp, E2, O1, A1 etc.) is used throughout this disclosure. However, while O-RAN is a clear leader in standardizing the Open RAN architecture, it should also be noted that other organizations such as, for example, the Telecom Infra Project (TIP), are also working in this area. Therefore, it will be apparent in view of this disclosure that, although O-RAN nomenclature is used throughout for convenience, the systems and methods provided herein can be used in connection with any Open RAN architecture in accordance with various embodiments.

Generally, OrchestRAN is designed to be executed as an rApp (or equivalent) at a non-real-time RIC (“non-RT RIC”). Ata high-level, OrchestRAN provides software and abstraction modules such that telcos can specify their intent and goals (step I). This includes the set of functionalities they want to deploy (e.g., network slicing, beamforming, scheduling control, etc.), the location where functionalities are to be executed (e.g., RIC, Distributed Units (DUs), Centralized Units (CUs), Radio Units (RUS)) and the desired time constraint (e.g., delay-tolerant, low-latency). Then, requests are gathered by a Request Collector (step II) and fed to an Orchestration Engine (step III) which can (i) access a ML/AI Catalog and OrchestRAN Infrastructure Abstraction module to determine the optimal orchestration policy and models to be instantiated; (ii) automatically create executable software components with the ML/AI models embedded (e.g., in the form of O-RAN applications such as xApps at the near-real-time RIC, rApps at the non-real-time RIC, or dApps at CUs, DUs, or RUs), and (iii) dispatch such software components to the locations determined by the Orchestration Engine.

Furthermore, in order to facilitate such orchestration of the Open RAN, a set of optimization computer-implemented methods with diverse complexity/optimality tradeoffs have been developed such that OrchestRAN can provide approximate solutions in a few hundreds of milliseconds or optimal ones in a few seconds. In addition, a set of xApps embedding Deep Reinforcement Learning (DRL) solutions to control the RAN in real time via an interface such as an O-RAN E2 interface have been developed.

OrchestRAN, as described in greater detail, has also been prototyped on a wireless network emulator, known as Northeastern University's “Colosseum,” which is the first large-scale experimental effort for such a system.

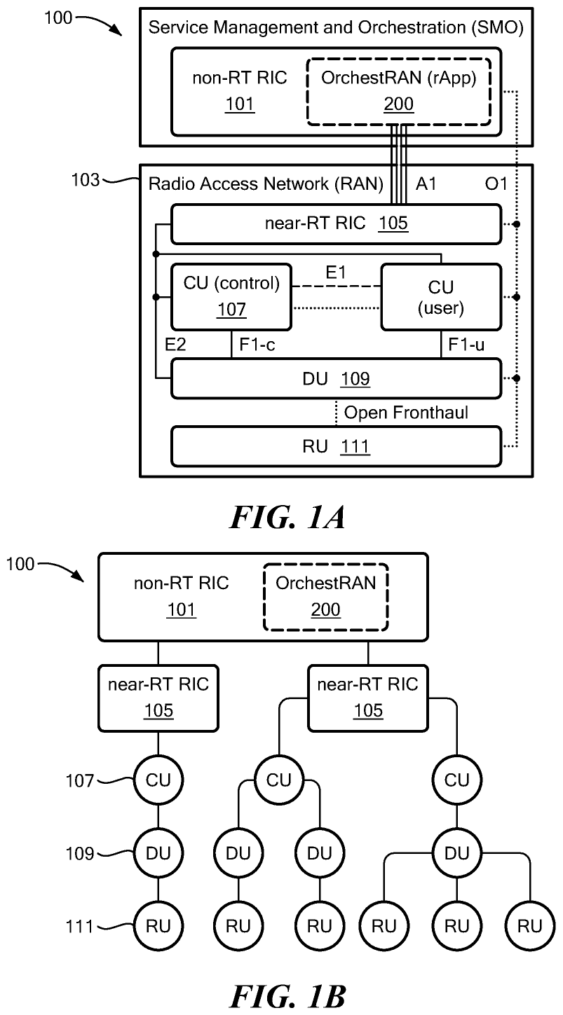

The OrchestRAN prototype follows O-RAN specifications and operates as an rApp executed in the non-RT RIC (FIGS. 1A-1B) providing automated routines to: (i) collect requests from Telcos; (ii) select the optimal ML/AI models to achieve Telcos' goals; and (iii) determine the optimal execution location for each model complying with time-scale requirements, resource and data availability, and (iv) automatically embed ML/AI models into software components (e.g., e.g., software containers such as docker containers of dApps, xApps, and/or rApps, virtual machines, microservices, and/or standalone executable software) that are dispatched to selected nodes to be executed and fed with required inputs.

To achieve this goal and facilitate more efficient operation of the OrchestRAN system novel orchestration problems have been designed and prototyped as described below embedding pre-processing variable reduction and branching techniques that allow OrchestRAN to compute orchestration solutions with different complexity and optimality trade-offs, while ensuring that the Telcos intents are satisfied. The performance of OrchestRAN in orchestrating intelligence in the RAN is evaluated through numerical simulations, and by prototyping OrchestRAN on Colosseum, the world's largest wireless network emulator with hardware in the loop. Experimental results on an O-RAN-compliant softwarized network with 7 cellular base stations and 42 users demonstrate that OrchestRAN enables seamless instantiation of O-RAN applications with different time-scale requirements at RAN components. OrchestRAN automatically selects the optimal execution locations for each O-RAN application, thus moving network intelligence to the edge with up to 2.6× reduction of control overhead over O-RAN open interfaces. To the inventors' knowledge, this is the first large-scale demonstration of an O-RAN-compliant network intelligence orchestration system.

### O-RAN Primer

O-RAN 100 embraces the 3GPP 7-2× functional split where network functionalities are split across multiple nodes, namely, CUs 107, DUs 109, and RUs 111 as shown in FIGS. 1A and 1B. The RUs 111 implement lower physical layer functionalities. The DUs 109 interact with the RUs via the Open Fronthaul interface and implement functionalities pertaining to both the higher physical layer and the Medium Access Control (MAC) layer. Finally, the remaining functionalities of the protocol stack are implemented and executed in the CU 107. The latter is connected to the DUs 109 through the F1 interface and is further split in two entities—interconnected through the E1 interface—that handle control and user planes. All network elements—instantiated on “white-box” hardware and interconnected through open and standardized interfaces—are designed to enable multi-vendor interoperability and overcome the obsolete vendor lock-in. Beyond disaggregation, the main innovation introduced by O-RAN 100 lies in the non-RT RIC 101 and near-RT RIC 105. These components enable dynamic and softwarized control of the RAN 103, as well as the collection of statistics via a publish-subscribe model through open and standardized interfaces, e.g., the O1 and E2 interfaces (FIG. 1A). Specifically, the near-RT RIC 105 hosts applications (xApps) that implement time-sensitive—i.e., between 10 ms and 1 s—operations to perform closed-loop control over the RAN 103 elements. Practical examples include control of load balancing, handover procedures, scheduling and RAN slicing policies. The non-RT RIC 101, instead, is designed to execute within a service management and orchestration (SMO) framework, e.g., Open Network Automation Platform (ONAP), and acts at time scales above 1 s. It takes care of training ML/AI models, as well as deploying models and network control policies on the near-RT RIC 105 through the A1 interface. Similar to its near-RT counterpart, the non-RT RIC 101 supports the execution of third-party applications, called rApps. These components act in concert to gather data and performance metrics from the RAN, and to optimize and reprogram its behavior in real time through software algorithms to reach Telco's goals. O-RAN specifications also envision ML/AI models instantiated directly on the CUs 107 and DUs 109, implementing RT-Transmission Time Interval (TTI) level-control loops that operate on 10 ms time-scales. Although these are left for future O-RAN extensions, OrchestRAN 200 has been natively designed to support such control loops, implementing RT applications, referred to as dApps (described in greater detail below) to avoid confusion.

### Orchestran

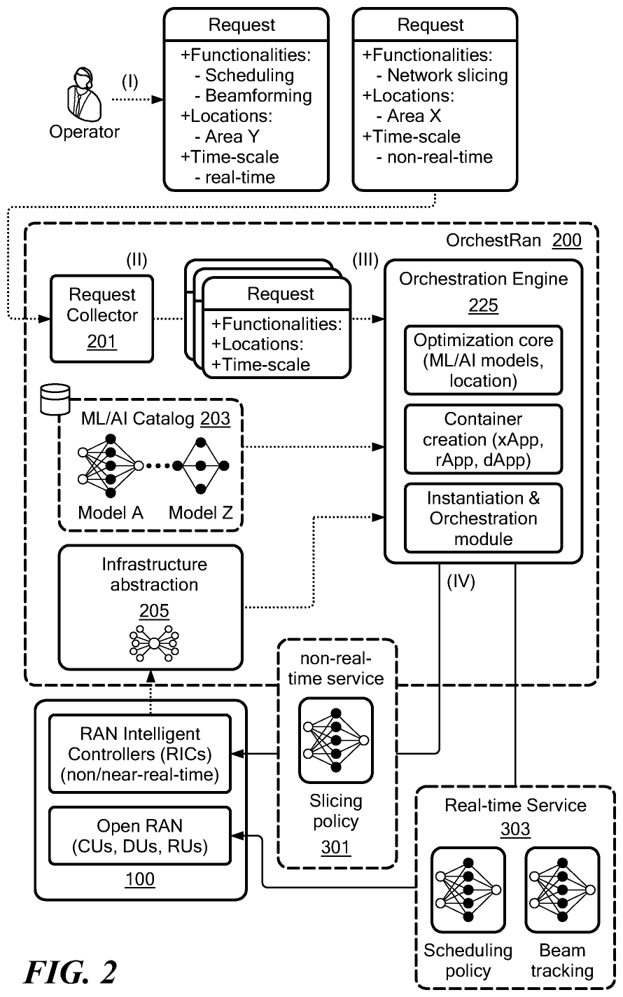

As illustrated in FIGS. 1A-1B, OrchestRAN 200 is designed to be executed as an rApp at the non-RT RIC 101. Its architecture is illustrated in FIG. 2. At a high-level, first Telcos specify their intent by submitting a request to OrchestRAN 200. This includes the set of functionalities they want to deploy (e.g., network slicing, beamforming, scheduling control, etc.), the location where functionalities are to be executed (e.g., RIC, CU, DU) and the desired time constraint (e.g., delay-tolerant, low-latency). More generally, OrchestRAN is operative to satisfy any request that specifies desired control, prediction, and/or classification functionalities. Then, requests are gathered by the Request Collector 201 and fed to the Orchestration Engine 225 which: (i) Accesses the ML/AI Catalog 203 and the Infrastructure Abstraction module 205 to determine the optimal orchestration policy and models to be instantiated; (ii) automatically creates software components 301, 303 with the ML/AI models embedded therein, and (iii) dispatches such software components at the locations determined by the Orchestration Engine 225.

### A. The Infrastructure Abstraction Module

The infrastructure abstraction module 205 provides a high-level representation of the physical RAN architecture, which is divided into five separate logical groups: non-RT RICs 101, near-RT RICs 105, CUs 107, DUs 109, and RUs 111. Each group contains a different number of nodes deployed at different locations of the network. Let D be the set of such nodes, and D=|D| be their number. The hierarchical relationships between nodes can be represented via an undirected graph with a tree structure such as the one in FIG. 1B. Specifically, leaves represent nodes at the edge (e.g., RUs/DUs/CUs), while the non-RT RIC is the root of the tree. Coexisting CUs/DUs/RUs are modeled as a single logical node with a hierarchy level equal to that of the hierarchically highest node in the group.

For any two nodes d′, d″∈D, define variable Cd′, d″∈{0,1} such that Cd′, d″ if node d′ is reachable from node d″ (e.g., there exist a communication link such that node d′ can forward data to node d″), Cd′, d″=0 otherwise. In practical deployments, it is reasonable to assume that nodes on different branches of the tree are unreachable. Moreover, for each node d∈D, let p_{d}^{ξ} be the total amount of resources of type ξ∈Ξ dedicated to hosting and executing ML/AI models and their functionalities, where Ξ represents the set of all resource types. Although no assumptions are made about the specific types of resources, practical examples may include the number of CPUs, GPUs, as well as available disk storage and memory. In the following, it is assumed that each non-RT RIC identifies an independent networking domain and the set of nodes D includes near-RT RICs, CUs, DUs and RUs controlled by the corresponding non-RT RIC only.

### B. The ML/AI Catalog

In OrchestRAN 200, the available pre-trained data-driven solutions are stored in a ML/AI Catalog 203 including of a set M of ML/AI models. Let F be the set of all possible control and inference functionalities (e.g., scheduling, beamforming, capacity forecasting, handover prediction) offered by such ML/AI models—hereafter referred to simply as “models”.

Let M=|M| and F=|F|. For each model m∈M, Fₘ⊂ F represents the subset of functionalities offered by m. Accordingly, define a binary variable σ_{m,ƒ}∈{0,1} such that σ_{m,ƒ}=1 if ƒ∈Fₘ, σ_{m,ƒ}=0 otherwise. Use pₘ^{ξ} to indicate the amount of resources of type ξ∈Ξ required to instantiate and execute model m. Let T be the set of possible input types. For each model m∈M, t^{IN}ₘ∈T represents the type of input required by the model (e.g., IQ samples, throughput and buffer size measurements). Naturally, not all models can be equally executed everywhere. For example, a model m performing beam alignment, in which received IQ samples are fed to a neural network to determine the beam direction, can only execute on nodes where IQ samples are available. While IQ samples can be accessed in real-time at the RU, they are unlikely to be available at CUs and the RICs without incurring in high overhead and transmission latency. For this reason, a suitability indicator β_{m,ƒ,d}€[0,1] is introduced which specifies how well a model m is suited to provide a specific functionality ƒ∈F when instantiated on node d. Values of β_{m,ƒ,d} closer to 1 mean that the model is well-suited to execute at a specific location, while values closer to 0 indicate that the model performs poorly. A performance score γ_{m,ƒ} is also introduced measuring the performance of the model with respect to ƒ∈F. Typical performance metrics include classification/forecasting accuracy, mean squared error and probability of false alarm. A model can be instantiated on the same node multiple times to serve different Telcos or traffic classes. However, due to limited resources, each node d supports at most C_{m,d}=min_{∈∈Ξ}{|p_{d}^{ξ}/pₘ^{ξ}|} instances of model m, where └⋅┘ is the floor operator.

### C. Request Collector

OrchestRAN allows Telcos to submit requests specifying which functionalities they require, where they should execute, and the desired performance and timing requirements. Without loss of generality, assume that each request is feasible. The Request Collector 201 of OrchestRAN 200 is in charge of collecting such requests. A request i is defined as a tuple (Fᵢ, πᵢ, δᵢ, Dᵢ^{IN}), with each element defined as follows:

Functions and locations. For each request i, define the set of functionalities that must be instantiated on the nodes as Fᵢ=(F_{i,d})_{d∈D}, with F_{i,d}⊂F. Required functionalities and nodes are specified by a binary indicator τ_{i,ƒ,d}∈{0,1} such that τ_{i,ƒ,d}=1 if request i requires functionality ƒ on node d, i.e. ƒ∈F_{i,d}, τ_{i,ƒ,d}=0 otherwise. also define Dᵢ={d∈D: τ_{ƒ∈F}_{ᵢ} _{τ}_{_{i,ƒ,d}}≥1} as the subset of nodes of the network where functionalities in Fᵢ should be offered;

Performance requirements. For any request i, πᵢ=(τ_{i,ƒ,d})_{d∈D}_{ᵢ}_{,ƒ∈F}_{_{i,d}} indicates the minimum performance requirements that must be satisfied to accommodate i. For example, if ƒ is a beam detection functionality, π_{i,ƒ,d} can represent the minimum detection accuracy of the model. No assumptions on the physical meaning of π_{i,ƒ,d} are made because it reasonably differs from one functionality to the other.

Timing requirements. Some functionalities might have strict latency requirements that make their execution at nodes far away from the location where the input is generated impractical or inefficient. For this reason, δ_{i,ƒ,d}≥0 represents the maximum latency request i can tolerate to execute ƒ on d;

Data source. For each request i, the Telco also specifies the subset of nodes whose generated (or collected) data must be used to deliver functionality ƒ on node d. This set is defined as Dᵢ^{IN}=(D_{i,ƒ,d}^{IN})_{d∈D}_{ᵢ}_{,ƒ∈F}_{_{i,d}}, where D_{i,ƒ,d}^{IN}⊂D. This information is paramount to ensure that each model is fed with the proper data generated by the intended sources only. For any tuple (i,ƒ,d) assume that C_{d,d′}=1 for all d′∈D_{i,ƒ,d}^{IN}. Hereinafter, I is used to represent the set of outstanding requests with I=|I| being their number.

### D. The Orchestration Engine

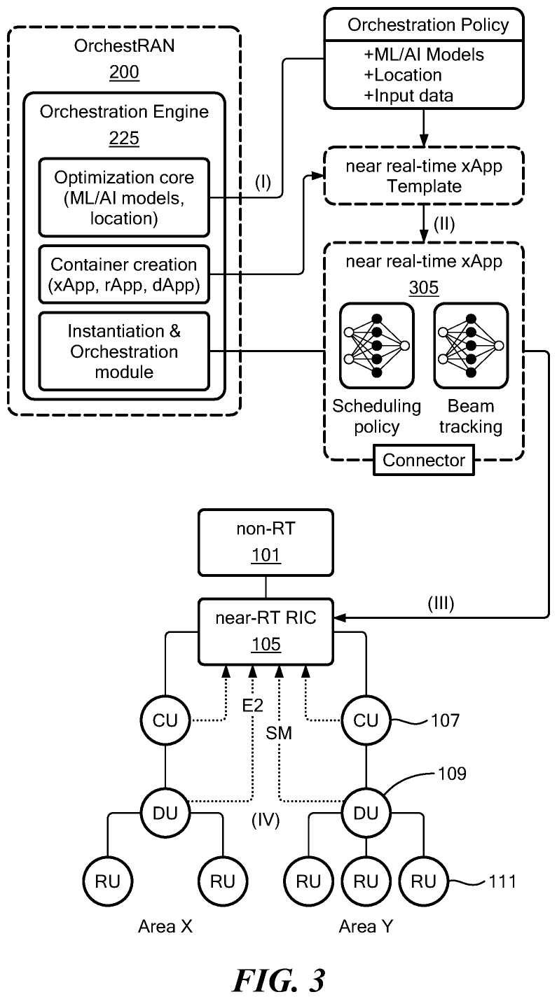

As depicted in FIG. 3, once requests are submitted to OrchestRAN 200, the Orchestration Engine selects the most suitable models from the ML/AI Catalog 203 and the location where they should execute (step I). Then, OrchestRAN 200 embeds the models into software components 301, 303, 305 (e.g., software containers such as docker containers of dApps, xApps, and/or rApps, virtual machines, microservices, and/or standalone executable software) (step II) and dispatches them to the selected nodes 101, 105, 107, 109, 111 (step III). Here, they are fed data from the RAN and execute their functionalities (step IV). The selection of the models and of their optimal execution location is performed by solving the orchestration problem discussed in detail below. This results in an orchestration policy, which is converted into a set of software components that are dispatched and executed at the designated network nodes, as discussed next.

Software Component creation, dispatchment and instantiation. In some embodiments, to embed models in different software components, the software components can be software containers (e.g., O-RAN applications such as xApps, rApps, or dApps). The software containers can integrate two subsystems, which are automatically compiled from descriptive files upon instantiation. The first is the model itself, and the second is an application-specific connector. This is a library that interfaces with the node where the application is running (i.e., with the DU in the case of dApps, near-RT RIC for xApps, and non-RT RIC for rApps), collects data from Dᵢ^{IN} and sends control commands to nodes in Dᵢ. Once the containers are generated, OrchestRAN dispatches them to the proper endpoints specified in the orchestration policy, where they are instantiated and interfaced with the RAN to receive input data. For example, xApps automatically send an E2 subscription request to nodes in Dᵢ^{IN}, and use custom Service Models (SMs) to interact with them over the E2 interface (see FIG. 3).

### The Orchestration Problem

Before formulating the orchestration problem, important properties of Open RAN systems are discussed below.

Functionality outsourcing. any functionality that was originally intended to execute at node d′ can be outsourced to any other node d″∈D as long as C_{d′,d″}=1. As described below, the node hosting the outsourced model must have access to the required input data, have enough resources to instantiate and execute the outsourced model, and must satisfy performance and timing requirements of the original request.

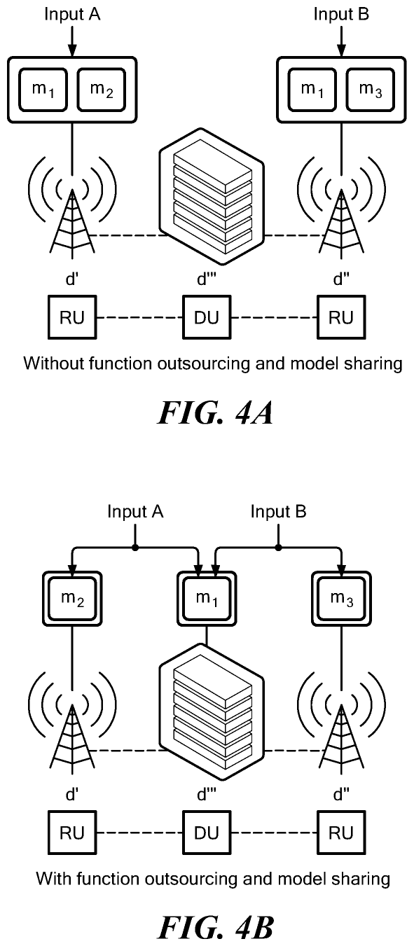

Model sharing. The limited amount of resources, especially at DUs and RUs, calls for efficient resource allocation strategies. If multiple requests involve the same functionalities on the same group of nodes, an efficient approach includes deploying a single model that can be shared across all requests. For the sake of clarity, FIG. 4A shows an example where a request can be satisfied by instantiating models m₁ and m₂ on d′, and a second one that can be accommodated by instantiating models m₁ and m₃ on d″. FIG. 4B shows an alternative solution where m₁ (common to both requests) is outsourced to d′″ and it is shared between the two requests, with a total of three deployed models, against the four required in FIG. 4A. Nevertheless, as explained in more detail below, it will be apparent in view of this disclosure that there may be cases where model sharing or function outsourcing are nonviable and/or undesirable.

### A. Formulating the Orchestration Problem

Let x_{m,k,d′}^{i,ƒ,d}∈{0,1} be a binary variable such that x_{m,k,d′}^{i,ƒ,d}=1 l if functionality ƒ demanded by request i on node d is provided by instance k of model m instantiated on node d′. In the following, refer to the variable x=(x_{m,k,d′}^{i,ƒ,d})_{i,ƒ,d,m,k,d′} as the orchestration policy, where i∈I, ƒ∈F, (d, d′)∈D×D, m∈M, k=1 . . . . C_{m,d′}. For any tuple (i,ƒ,d) such that τ_{i,ƒ,d}=1, assume that OrchestRAN can instantiate at most one model. As mentioned earlier, this can be achieved by either instantiating the model at d, or by outsourcing it to another node d′≠d. The above requirement can be formalized as follows:

$${\sum }_{m ∈ ℳ} {σ}_{m , f} {\sum }_{{d}^{′} ∈ D} {\sum }_{k = 1}^{{C}_{m , {d}^{′}}} {C}_{d , {d}^{′}} {x}_{m , k , {d}^{′}}^{i , f , d} = {i}_{} {τ}_{i} , f , d \qquad ( 1 )$$

where yᵢ∈{0,1} indicates whether or not i is satisfied. Specifically, (1) ensures that: (i) For any tuple (i,ƒ,d) such that τ_{i,ƒ,d}=1, function ƒ is provided by one model only, and (ii) yᵢ=1 (i.e., request i is satisfied) if and only if OrchestRAN deploys models providing all functionalities specified in Fᵢ.

Complying with the requirements. An important aspect of the orchestration problem is guaranteeing that the orchestration policy x satisfies the minimum performance requirements πᵢ of each request i, and that both data collection and execution procedures do not exceed the maximum latency constraint δ_{i,ƒ,d}. These requirements are captured by the following constraints.

1) Quality of models: For each tuple (i,ƒ,d) such that τ_{i,ƒ,d}=1, Telcos can specify a minimum performance level π_{i,ƒ,d}. This can be enforced via the following constraint:

$${χ}_{i , f , d} {\sum }_{m ∈ ℳ} {\sum }_{{d}^{′} ∈ D} {\sum }_{k = 1}^{{C}_{m , {d}^{′}}} {C}_{d , {d}^{′}} {x}_{m , k , {d}^{′}}^{i , f , d} {A}_{m , f , d} \geq {χ}_{i , f , d} {i}_{} {π}_{i , f , d} \qquad ( 2 )$$

where A_{m,ƒ,d}=β_{m,ƒ,d} γ_{m,ƒ} σ_{m,ƒ}, and the performance score γ_{m,ƒ} is defined below. In (2), ω_{i,ƒ,d}=1 if the goal is to guarantee a value of γ_{m,ƒ} higher than a minimum performance level π_{i,ƒ,d}, and ω_{i,ƒ,d}=−1 if the goal is to keep γ_{m,ƒ} below a maximum value π_{i,ƒ,d}.
2) Control-loop time-scales: Each model m requires a specific type of input tₘ^{IN} and, for each tuple (i,ƒ,d), it must be ensured that the time needed to collect such input from nodes in D_{i,ƒ,d}^{IN} does not exceed δ_{i,ƒ,d}. For each orchestration policy x, the data collection time can be formalized as follows:

$${Δ}_{i , f , d} ( x ) {\sum }_{m ∈ ℳ} {σ}_{m , f} {\sum }_{{d}^{′} ∈ D} {\sum }_{k = 1}^{{C}_{m , {d}^{′}}} {x}_{m , k , {d}^{′}}^{i , f , d} {\sum }_{{d}^{″} ∈ {D}_{i , f , d}^{IN}} {C}_{{d}^{′} , {d}^{″}} {Θ}_{m , {d}^{′} , {d}^{″}}^{i , f , d} \qquad ( 3 )$$

$$where$$

$${Θ}_{m , {d}^{′} , {d}^{″}}^{i , f , d} = ( \frac{{S}_{{t}_{m}^{IN}}}{{b}_{{d}^{′} , {d}^{″}} \vert {D}_{i , f , d}^{IN} \vert} + {T}_{{d}^{′} , {d}^{″}} ) ,$$

Sₜ_{ₘ}_{^{IN}} is the input size of model m measured in bytes, b_{d′,d″} is the data rate of the link between nodes d′ and d′, and τ_{d′,d″} represents the propagation delay between nodes d′ and d″. Let τₘ^{exec} be the time to execute model m on node d′. For any tuple (i,ƒ,d), the execution time under orchestration policy x is

$${Δ}_{i , f , d}^{EXEC} ( x ) = {\sum }_{m ∈ ℳ} {σ}_{m , f} {\sum }_{{d}^{′} ∈ D} {T}_{m , {d}^{′}}^{exec} {\sum }_{k = 1}^{{C}_{m , {d}^{′}}} {x}_{m , k , {d}^{′}}^{i , f , d} \qquad ( 4 )$$

By combining (3) and (4), any orchestration policy x must satisfy the following constraint for all (i,ƒ,d) tuples:

$${Δ}_{i , f , d} ( x ) + {Δ}_{i , f , d}^{EXEC} ( x ) \leq {δ}_{i , f , d} {τ}_{i , f , d} \qquad ( 5 )$$

Avoiding resource over-provisioning. It must be guaranteed that the resources consumed by the software components do not exceed the resources ρ_{d}^{ξ} of type ξ available at each node (i.e., ρ_{d}^{ξ}). For each d∈D and ξ∈Ξ

$${\sum }_{m ∈ ℳ} {ρ}_{m}^{ξ} {\sum }_{k = 1}^{{C}_{m , d}} {z}_{m , k , d} \leq {ρ}_{m}^{ξ} \qquad ( 6 )$$

where z_{m,k,d}∈{0,1} indicates whether instance k of model m is associated to at least one model on node d. Specifically, let

$${n}_{m , k , d} = {\sum }_{i ∈ I} {\sum }_{f ∈ F} {\sum }_{{d}^{′} ∈ D} {x}_{m , k , {d}^{′}}^{i , f , d} \qquad ( 7 )$$

be the number of tuples (i, ƒ, d′) assigned to instance k of model m on node d (n_{m,k,d}>1 implies that m is shared). Notice that (6) and (7) are coupled one to another as z_{m,k,d}=1 if and only if n_{m,k,d}>0. This conditional relationship can be formulated by using the following big-M formulation:

$${n}_{m , k , d} \geq 1 - M ( 1 - {z}_{m , k , d} ) \qquad ( 8 )$$

$${n}_{m , k , d} \leq {Mz}_{m , k , d} \qquad ( 9 )$$

where M∈R is a real-valued number whose value is larger than the maximum value of n_{m,k,d}, i.e., M>IFD.

Problem formulation. For any request i, let vᵢ≥0 represent its value. The goal of OrchestRAN is to compute an orchestration policy x maximizing the total value of requests being accommodated by selecting (i) which requests can be accommodated; (ii) which models should be instantiated; and (iii) where they should be executed to satisfy request performance and time-scale requirements. This can be formulated as

$${max}_{x , y , z} {\sum }_{i ∈ I} {i}_{} {v}_{i} \qquad ( 10 )$$

subject to Constraints (1), (2), (5), (6), (8), (9)

$${x}_{m , k , {d}^{′}}^{i , f , d} ∈ \{ 0 , 1 \} \qquad ( 11 )$$

$${i}_{} ∈ \{ 0 , 1 \} \qquad ( 12 )$$

$${z}_{m , k , d} ∈ \{ 0 , 1 \} \qquad ( 13 )$$

where x is the orchestration policy, y=(yᵢ)_{m∈M,k=1, . . . , C}_{_{m,d,d∈D}}. A particularly relevant case is that where vᵢ=1 for all i∈I, i.e., the goal of OrchestRAN is to maximize the number of satisfied requests.

Disabling model sharing. Indeed, model sharing allows a more efficient use of the available resources. However, out of privacy and business concerns, Telcos might not be willing to share Open RAN applications. In this case, model sharing can be disabled in OrchestRAN by guaranteeing that a model is assigned to one request only. This is achieved by adding the following constraint for any m∈M, d′∈D and k=1, . . . , C_{m,d′}

$${\sum }_{i ∈ I} {\sum }_{d ∈ D} {\sum }_{f ∈ {F}_{i , d}} {x}_{m , k , {d}^{′}}^{i , f , d} \leq 1 \qquad ( 14 )$$

### B. NP-Hardness of the Orchestration Problem

Problem (10) is a Binary Integer Linear Programming (BILP) problem which can be shown to be NP-hard. The proof includes building a polynomial-time reduction of the 3-SAT problem (which is NP-complete) to an instance of Problem (10).

### Solving the Orchestration Problem

BILP problems such as Problem (10) can be optimally solved via Branch-and-Bound (B&B) techniques, readily available within well-established numerical solvers, e.g., CPLEX, MATLAB, Gurobi. However, due to the extremely large number N_{OPT} of optimization variables, these solvers might still fail to compute an optimal solution in a reasonable amount of time, especially in large-scale deployments. Indeed, N_{OPT}=|x|+|y|+|z|≈|x|, where |x|=O(IFD²MCₘₐₓ), |y|=O(I), [z]=O(MDCₘₐₓ), and Cₘₐₓ=max_{m∈M,d∈D}{C_{m,d}}. For example, a deployment with D=20, M=13, I=10, F=7 and Cₘₐₓ=3 involves ≈10⁶ optimization variables.

### A. Combating Dimensionality Via Variable Reduction

To mitigate the “curse of dimensionality” of the orchestration problem, two pre-processing algorithms were developed to reduce the complexity of Problem (10) while guaranteeing the optimality of the computed solutions. This is achieved by leveraging a technique called variable reduction. This exploits the fact that, due to constraints and structural properties of the problem, there might exist a subset of inactive variables whose value is always zero. These variables do not participate in the optimization process, yet they increase its complexity. To identify those variables, the following two techniques have been designed.

Function-aware Pruning (FP). FP identifies the set of inactive variables x_^{FP}={x_{m,k,d}_{¹}^{i,ƒ,d}; τ_{i,ƒ,d}=0 V σ_{m,ƒ}=0, ∀i∈I, ƒ∈F, (d, d′)∈D×D, m∈M, k=1, . . . C_{m,d}} which contains all of the x_{m,k,d}^{i,ƒ,d} variables such that either (i) τ_{i,ƒ,d}=0, i.e., request i does not require function fat node d, or (ii) σ_{m,ƒ}=0, i.e., model m does not offer function ƒ;

Architecture-aware Pruning (AP). This procedure identities those variables whose activation results in instantiating a model on a node that cannot receive input data from nodes in D_{i,ƒ,d}_{^{IN}}. Indeed, for a given tuple (i,ƒ,d) such that τ_{i,ƒ,d}=1, no model can be instantiated on a node d′ such that C_{d,d′}=0, i.e., the two nodes are not connected. The set of these inactive variables is defined as x_^{AP}={x_{m,k,d′}^{i,ƒ,d}: C_{d,d′}=0, ∀i∈I, ƒ∈F, (d, d′)∈D×D, m∈M, k=1, . . . , C_{m,d}}. Once all inactive variables have been identified, Problem (10) is cast into a lower-dimensional space where the new set of optimization variables is equal to \tilde{x}=x\{x_^{FP}∪x_^{AP}}, which still guarantees the optimality of the solution. The impact of these procedures on the complexity of the orchestration problem is described below.

### B. Graph Tree Branching

Notice that |x|=O(IFD²MCₘₐₓ), i.e., the number of variables of the orchestration problem grows quadratically in the number D of nodes. Since the majority of nodes of the infrastructure are RUs, DUs and CUs, it is reasonable to conclude that these nodes are the major source of complexity. Moreover, Open RAN systems operate following a cluster-based approach where each near-RT RIC controls a subset of CUs, DUs and RUs of the network only, i.e., a cluster, which have none (or limited) interactions with nodes from other clusters.

These two intuitions are the rationale behind the low complexity and scalable solution proposed herein, which includes splitting the infrastructure tree into smaller sub-trees—each operating as an individual cluster—and creating sub-instances of the orchestration problem that only accounts for requests and nodes regarding the considered sub-tree. The main steps of this algorithm are:
Step I: Let C be the number of near-RT RICs in the non-RT RIC domain. For each cluster c, the c-th sub-tree [symbol] _{c}⊂ [symbol] is defined such that [symbol] =∪_{c=1}^{c} [symbol] _{c} and ∩_{c=1}^{c} [symbol] _{c}=d^{root} with d^{root} being the non-RT RIC. A variable a_{d,c}∈{0,1} is used to determine whether a node d∈D belongs to cluster c (i.e. a_{d,c}=1) or not (i.e., a_{d,c}=0). Since ∩_{c=1}^{c} [symbol] _{c}=d^{root}, Σ_{c=1}^{c}a_{d,c}=1 for any d∈D\{d^{root}};

TABLE I
CONTROLLABLE NODES.

| | Requested Nodes | | | | |
|---|---|---|---|---|---|
| Case | nonRT RIC | nearRT RIC | CU | DU | RU |
| All nodes (ALL) | ✓ | ✓ | ✓ | ✓ | ✓ |
| Edge and RAN (ER) | X | ✓ | ✓ | ✓ | ✓ |
| RAN only (RO) | X | X | ✓ | ✓ | ✓ |

TABLE II
REQUEST TIME SCALE CASES AN PROBABILTIES.

| | Time scale | | |
|---|---|---|---|
| Case | TTI-level - ≤0.01 s | Sub-second - ≤1 s | Long - >1 s |
| Delay-Tolerant (DT) | 0.2 | 0.2 | 0.6 |
| Low Latency (LL) | 0.2 | 0.6 | 0.2 |
| Ultra-Low Latency (ULL) | 0.6 | 0.4 | 0 |

Step II: For each sub-tree D_{c} the subset I_{c}⊂I is identified such that I_{c}={i∈I: τ_{ƒ∈F}Σ_{d∈D}_{_{c}}τ_{i,ƒ,d}≥} contains all the requests that involve nodes belonging to cluster c only;
Step III: Solve Problem (10) via B&B considering only requests in I_{c} and nodes in D_{c}. The solution is a tuple (x_{c}, y_{c}, z_{c}) specifying which models are instantiated and where (x_{c}), which requests are satisfied in cluster c (y_{c}) and what instances of the models are instantiated on each node of D_{c} (z_{c}). This branching procedure might compute solutions with partially satisfied requests. These are requests that are accommodated on a subset of clusters only, which violates Constraint 1. However, as shown and described below, this procedure is scalable as each sub-tree D_{c} involves a limited number of nodes only, and each lower-dimensional instance of Problem (10) can be solved in parallel and in less than 0.1 s.

### Numerical Evaluation

To evaluate the performance of OrchestRAN in large-scale scenarios, a simulation tool has been developed in MATLAB that uses CPLEX to execute optimization routines. For each simulation, Telcos submit R=20 randomly generated requests, each specifying multiple sets of functionalities and nodes, as well as the desired time-scale. Unless otherwise stated, consider a single-domain deployment with 1 non-RT RIC, 4 near-RT RICs, 10 CUs, 30 DUs and 90 RUs. For each simulation, the number of network nodes is fixed, but the tree structure of the infrastructure is randomly generated. Consider the three cases shown in Table I, where the type of nodes that can be included in each request is limited. Similarly, also consider the three cases in Table II. For each case, the probability that the latency requirement δ_{i,ƒ,d} for each tuple (i,ƒ,d) is associated to a specific time scale is specified. The combination of these 6 cases covers relevant Open RAN applications.

The ML/AI Catalog includes M=13 models that provide F=7 different functionalities. Ten models use metrics from the RAN (e.g., throughput and buffer measurements) as input, while the remaining three models are fed with IQ samples from RUs. The input size S_{τIN}_{ₘ} is set to 100 and 1000 bytes for the metrics and IQ samples, respectively. For the sake of illustration, assume that β_{m,ƒ,d}=σ_{m,ƒ}, π_{i,ƒ,d}=τ_{i,ƒ,d} and C_{m,d}=3 for all m∈M, i∈F, ƒ∈F and d∈D. The execution time of each model is equal across all models and nodes and set to τ_{m,d}^{exec}=1 ms. The available bandwidth b_{d,d′} is 100 Gbps between non-RT RIC and near-RT RIC, 50 Gbps between near-RT RICs and CUs, 25 Gbps between CUs and DUs, and 20 Gbps between DUs and RUs, while the propagation delay τ_{d,d′} is set to [10,10,5,1] ms, respectively. The resources ρ_{d} available at each node are represented by the number of available CPU cores, and assume that each model requests one core only, i.e., ρₘ=1. The number of cores available at non-RT RICs, near-RT RICs, CUs, DUs and RUs are 128, 8, 4, 2, and 1, respectively. Results presented in this section are averaged over 100 independent simulation runs.

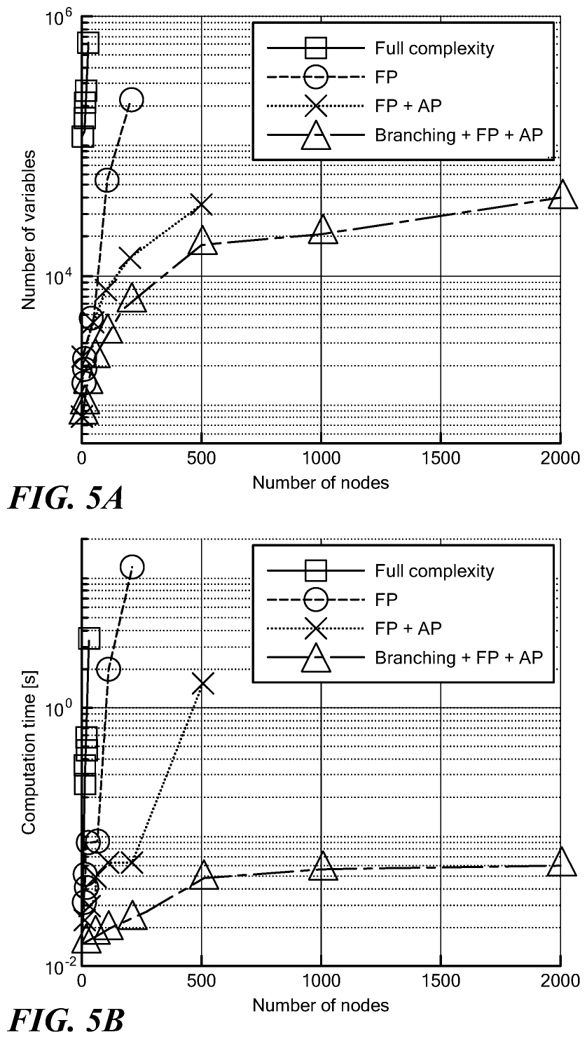

Computational complexity. FIGS. 5A and 5B show the number of optimization variables and computation time of the orchestration problem with varying network size. At each simulation run, consider a single non-RT RIC and a randomly generated tree graph that matches the considered size. As expected, the number of variables and the complexity increase with larger networks. This can be mitigated by using the described FP and AP pre-processing algorithms, which reduce the number of optimization variables while ensuring the optimality of the computed solution. Their combination allows computation of optimal solutions in 0.1 s and 2 s for networks with 200 and 500 nodes, respectively. FIGS. 5A and 5B also shows the benefits of branching the optimization problem into sub-problems of smaller size. Although the branching procedure might produce partially satisfied requests, it results in a computation time lower than 0.1 s even for instances with 2000 nodes, providing a fast and scalable solution for large-scale applications.

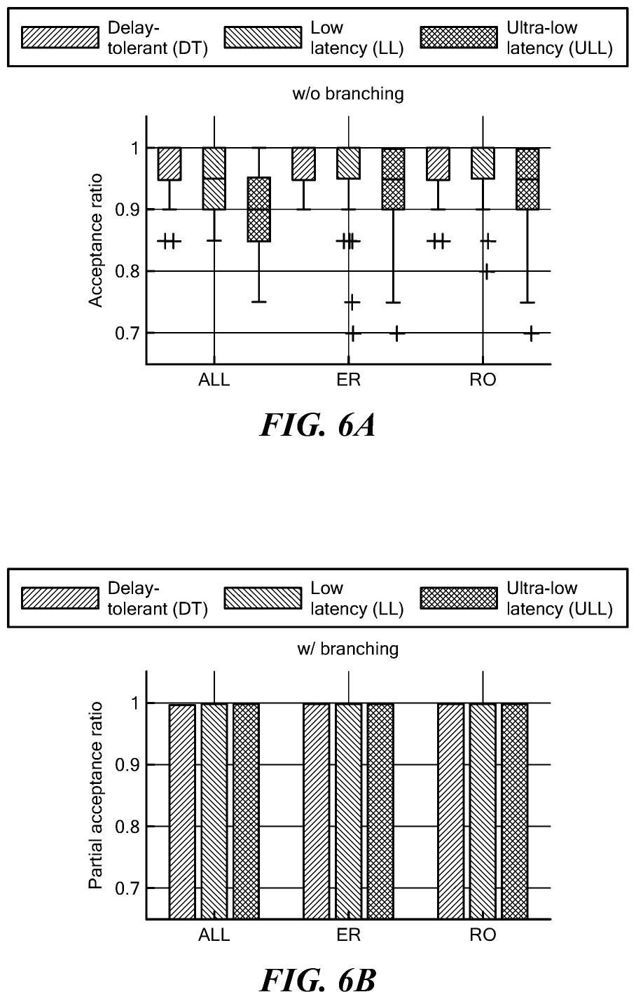

Acceptance ratio. FIG. 6A shows the acceptance ratio for different cases and algorithms. The number of accepted requests decreases when moving from loose timing requirements (i.e., Delay-tolerant (DT)), to tighter ones (i.e., Low Latency (LL) and Ultra-Low Latency (ULL)). For example, while 95% of requests are satisfied on average for the DT configuration, observe ULL instances in which only 70% of requests are accepted. Indeed, TTI-level services may only be possible at the DUs/RUs which, however, have limited resources and cannot support the execution of many concurrent software components (e.g., O-RAN applications). FIG. 6B, shows the probability that a request is partially accepted when considering the branching algorithm. Specifically, it shows that branching results in ≈99% of requests being partially satisfied on one sub-tree or more. This means that in the case where not enough resources are available to accept the entirety of the request, OrchestRAN can satisfy portions of it. Thus, requests that would be otherwise rejected can be at least partially accommodated.

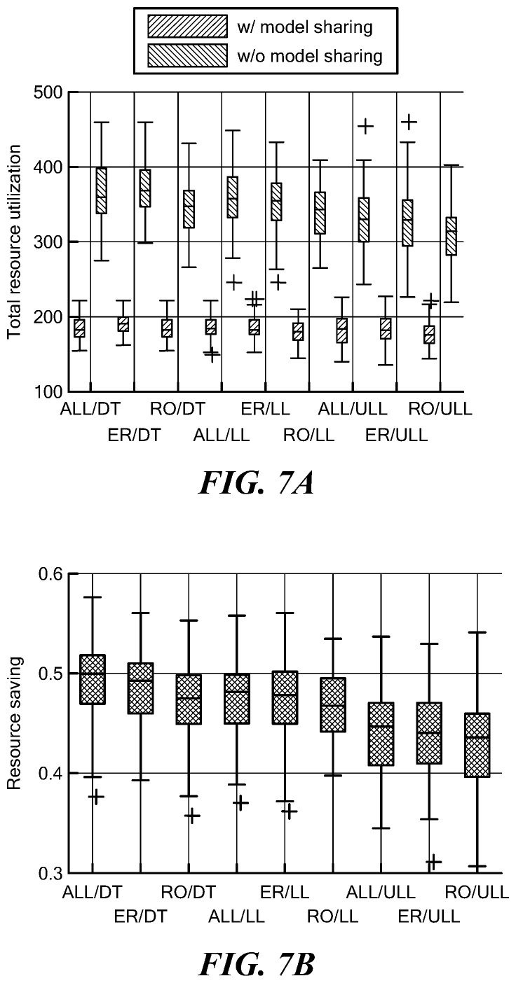

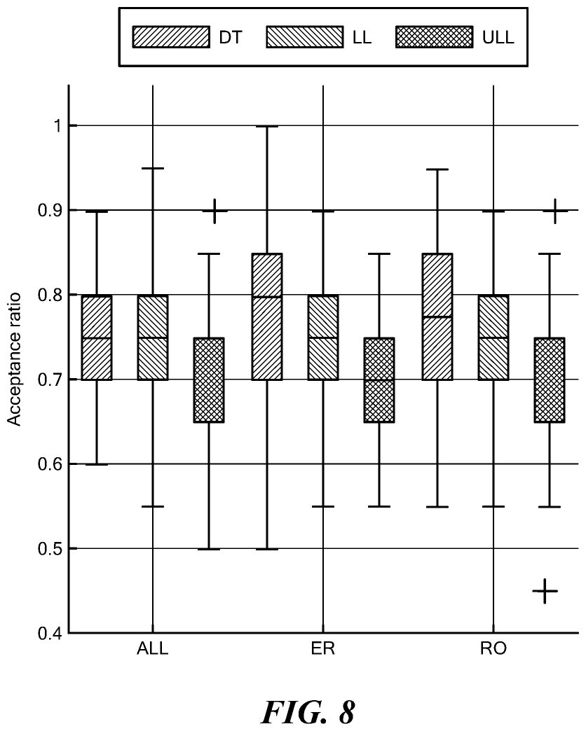

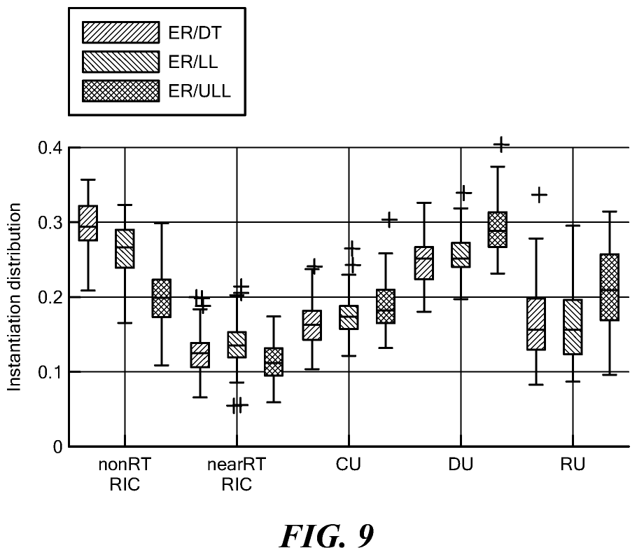

Advantages of model sharing. FIG. 7A shows the resource utilization with and without model sharing and FIG. 7B shows the corresponding resource utilization saving. As expected, model sharing always results in lower resource utilization and uses 2× less resources than the case without model sharing. FIG. 8 shows the acceptance ratio when model sharing is disabled, and by comparing it with FIG. 6A—where model sharing is enabled—it should be noticed that model sharing also increases the acceptance ratio. Specifically, model sharing accommodates at least 90% of requests in all cases, while this number drops to ≈70% when model sharing is disabled. To better understand how OrchestRAN orchestrates intelligence, FIG. 9 shows the distribution of models across the different network nodes for the ER case (see Table I) with different timing constraints. Requests with loose timing requirements (DT) result in ≈45% of models being allocated in the RICs. Instead, stringent timing constraints (LL and ULL) result in ≈70% of models being instantiated at CUs, DUs, and RUs.

### Prototype and Experimental Evaluation

To demonstrate the effectiveness of OrchestRAN, an O-RAN-compliant prototype was developed on Colosseum—the world's largest hardware in the loop network emulator. Colosseum includes 128 computing servers (i.e., Standard Radio Nodes (SRNs)), each controlling a USRP X310 Software-defined Radio (SDR), and a Massive Channel Emulator (MCHEM) emulating wireless channels between the SRNs via finite impulse response (FIR) filtering to reproduce realistic and time-varying wireless characteristics (e.g., path-loss, multipath) under different deployments (e.g., urban, rural, etc.).

TABLE III
DRL AGENTS IN THE ML/AI CATALOG

| | Reward | | | |
|---|---|---|---|---|
| | Slice 0 | Slice 1 | Slice 2 | Actions |
| M3 | max(Throughput) | max(TX pkts) | max(PRB ratio) | Scheduling |
| M4 | max(Throughput) | max(TX pkts) | max(Buffer size) | Scheduling, |
| | | | | RAN slicing |

The publicly available tool SCOPE was leveraged to instantiate a softwarized cellular network with 7 base stations and 42 User Equipment (UEs) (6 UEs per base station) on the Colosseum city-scale downtown Rome scenario, and to interface the base stations with the O-RAN near-RT RIC through the E2 interface. SCOPE, which is based on srsRAN, implements open Application Programming Interfaces (APIs) to reconfigure the base station parameters (e.g., slicing resources, scheduling policies, etc.) from O-RAN applications through closed-control loops, and to automatically generate datasets from RAN statistics (e.g., throughput, buffer size, etc.). Users are deployed randomly and generate traffic belonging to 3 different network slices configured as follows: (i) slice 0 is allocated an Enhanced Mobile Broadband (eMBB) service, in which each UE requests 4 Mbps constant bitrate traffic; (ii) slice 1 a Machine-type Communications (MTC) service, in which each UE requests Poisson-distributed traffic with an average rate of 45 kbps, and (iii) slice 2 to a Ultra Reliable and Low Latency Communication (URLLC) service, in which each UE requests Poisson-distributed traffic with an average rate of 90 kbps. Assume 2 UEs per slice, whose traffic is handled by the base stations, which use a 10 MHz channel bandwidth with 50 Physical Resource Block (PRB).

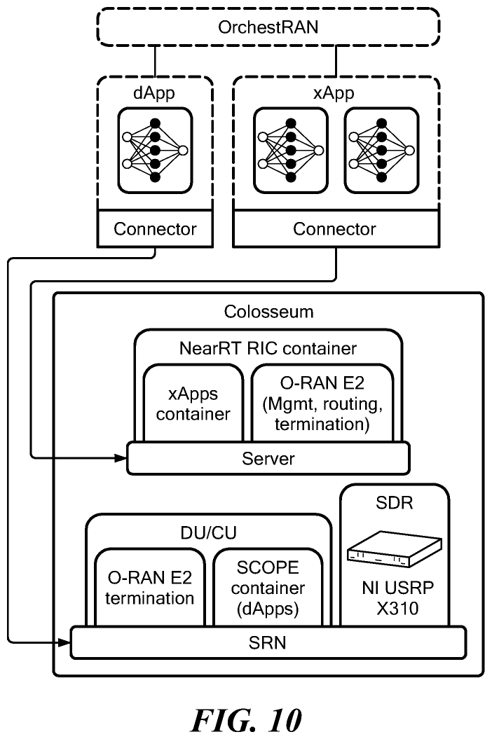

The high-level architecture of the OrchestRAN prototype on Colosseum is shown in FIG. 10. The OrchestRAN prototype runs in a Linux Container (LXC) embedding the components of FIG. 2. For each experiment, a new set of requests was randomly generated every 4 minutes. The Orchestration Engine computed the optimal orchestration policy and embedded the models within O-RAN applications that were dispatched to the nodes where they were executed. Consider the case where models can run at the near-RT RIC (as xApps) or at the DU (as dApps via SCOPE). SCOPE was used to generate datasets on Colosseum and train 4 ML models included in the ML/AI Catalog. Models M1 and M2 have been trained to forecast throughput and transmission buffer size. Models M3 and M4 control the Parameters of the network to maximize different rewards through Proximal Policy Optimization (PPO)-based DRL agents (see Table III). Specifically, M3 includes three DRL agents, each making decisions on the scheduling policies of one slice only. The three agents aim at maximizing the throughput of slice 0, the number of transmitted packets of slice 1, and the ratio between the allocated and requested PRBs (i.e., the PRB ratio which takes values in [0,1]) of slice 2, respectively. Model M4, instead, includes a single DRL agent controlling the scheduling and RAN slicing policies (e.g., how many PRBs are assigned to each slice) to jointly maximize the throughput of slice 0 and the number of transmitted packets of slice 1, and to minimize the buffer size of slice 2. Each model requires one CPU core and three configurations are considered: (i) “RIC only”, in which models can be executed via xApps at the near-RT RIC only; (ii) “RIC+lightweight DU”, in which DUs are equipped with 2 cores each to execute up to two dApps concurrently; and (iii) “RIC+powerful DU”, in which DUs are equipped with 8 cores. In all cases, the near-RT RIC has access to 50 cores. Overall, more than 95 hours of experiments were run on Colosseum.

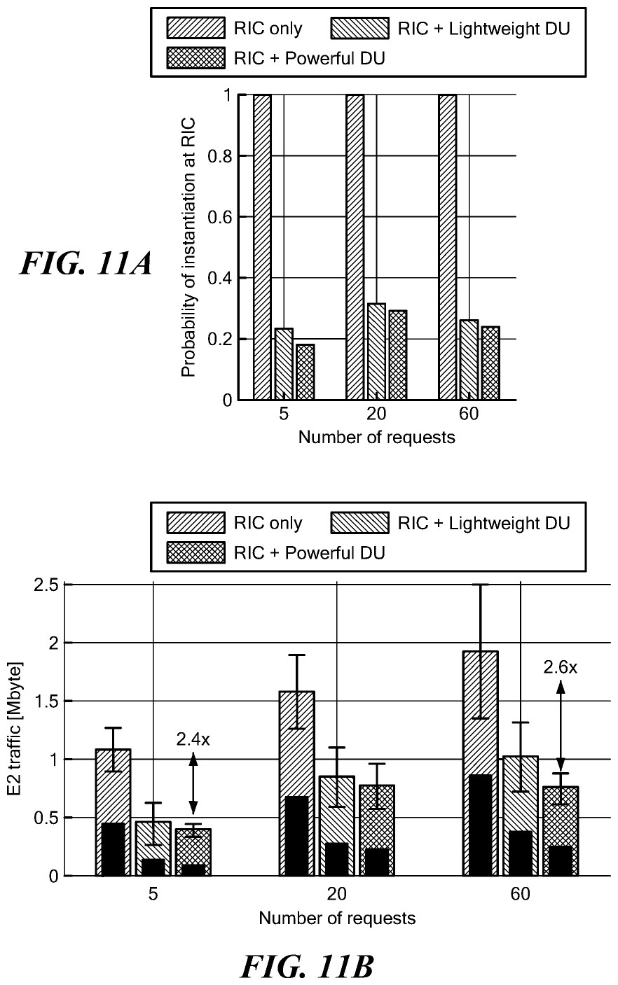

Experimental results. FIG. 11A shows the probability that models are executed at the near-RT RIC for different configurations and number of requests. As expected, in the “RIC only” case, all models execute as xApps at the near-RT RIC, while both “RIC+lightweight DU” and “RIC+powerful DU” cases result in ≈25% of models executing at the RIC. The remaining 75% of the models are executed as dApps at the DUs. FIG. 11B shows the traffic in Mbyte over the E2 interface between the near-RT RIC and the DUs for the different configurations. This includes messages to setup the initial subscription between the near-RT RIC and the DUs, messages to report metrics from the DUs to the RIC (e.g., throughput, buffer size), and control messages from the RIC to the DUs (e.g., to update scheduling and RAN slicing policies). Results clearly show that ≈40% of the E2 traffic transports payload information (dark bars), while the remaining 60% is overhead data. Although the initial subscription messages exchanged between the near-RT RIC and the DUs are sent in all considered cases, running models as dApps at the DUs still results in up to 2.6× less E2 traffic if compared to the “RIC only” case.

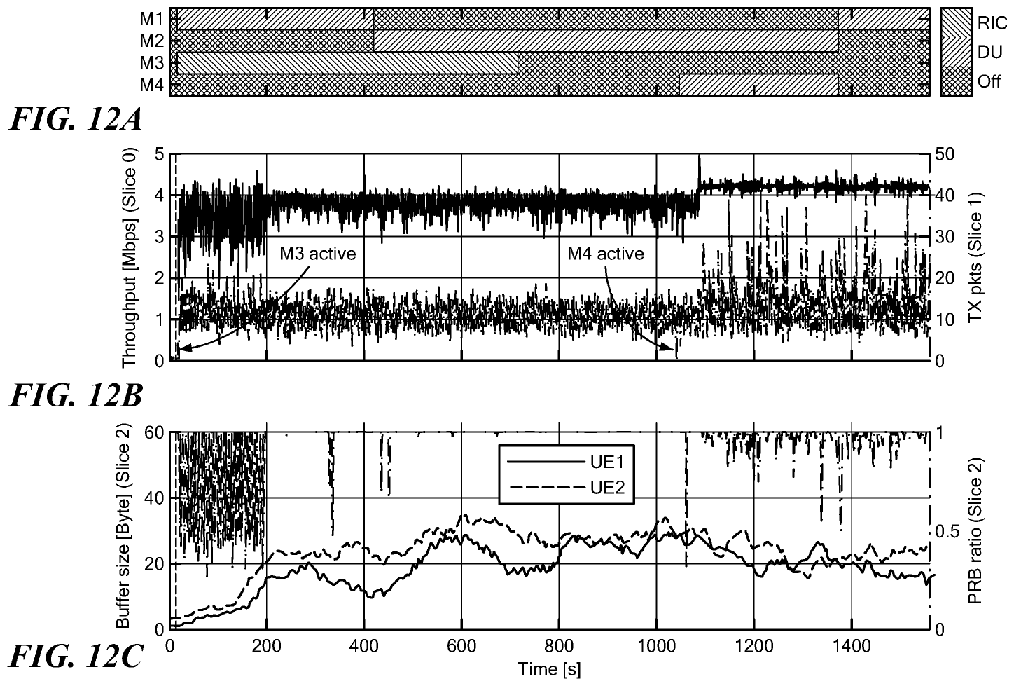

Finally, the impact of the real-time execution of OrchestRAN on the network performance is showcased. Focusing on DU 7, in FIG. 12A the location and time instant at which OrchestRAN instantiates the four models on the near-RT RIC and on DU 7 for a single experiment are shown. The impact on the network performance of the different orchestration policies is shown in FIGS. 12B and 12C. Since M1 and M2 perform forecasting tasks only, the figure only reports the evolution of the metrics used to reward the DRL agents M3 and M4 (see Table III) for different slices. It should be noted that OrchestRAN allows the seamless instantiation of dApps and xApps, controlling the same DU without causing any service interruptions. Moreover, although M3 and M4 share the same reward for slices 0 and 1, M4 can also make decisions on the network slicing policies. Thus, it provides a higher throughput for slice 0 (˜10% higher than M3), and a higher number of transmitted packets for slice 1 (≈2× higher than M3) (FIG. 12B). Similarly, in the case of slice 2, M3 aims at maximizing the PRB ratio, while M4 at minimizing the size of the transmission buffer, which results in M3 and M4 computing different control policies for slice 2. As shown FIG. 12C, although M3 converges to a stable control policy that results in a PRB ratio ≈1, its buffer size is higher than that of M4. Conversely, the buffer size of slice 2 decreases once M4 is instantiated with a decrease in the PRB ratio.

In summary, OrchestRAN is a novel network intelligence orchestration framework for Open RAN systems. OrchestRAN is based upon O-RAN specifications but compatible with any Open RAN architecture and leverages the RIC xApps and rApps and O-RAN open interfaces to provide Telcos with an automated orchestration tool for deploying data-driven inference and control solutions with diverse timing requirements. OrchestRAN has been equipped with orchestration algorithms with different optimality/complexity trade-offs to support non-RT, near-RT and RT applications. OrchestRAN performance was assessed and an O-RAN-compliant prototype was presented by instantiating a cellular network with 7 base stations and 42 UEs on the Colosseum network emulator. The experimental results demonstrate that OrchestRAN achieves seamless instantiation of O-RAN applications at different network nodes and timescales and reduces the message overhead over the O-RAN E2 interface by up to 2.6× when instantiating intelligence at the edge of the network.

Additional features, advantages, and uses of the described technology include, but are not limited to, the following:

### Example Features

New orchestration framework for network intelligence in Open RAN systems
First experimental demonstration of intelligence orchestration in a large-scale deployment following O-RAN specifications
Introduces the concept of dApps (described both above and in greater detail below), which are software components such as, for example, O-RAN applications running at CUs/DUs/RUs that are not yet defined in O-RAN specifications.
Demonstrates that executing dApps at the edge reduces overhead and enables real-time reconfiguration of RAN functionalities and parameters.
New computer-implemented methods to compute orchestration policies that account for maximum bounds on the time needed to gather input from network components and perform inference/control tasks via data-driven solutions.

### Example Advantages

Fully automated system for the deployment of network intelligence in the Open RAN.
Automated procedures to create dApps/xApps/rApps from scratch via templates that are filled with ML/AI models and connectors to receive/send input/output data.
Real-time execution on a prototype does not impact network service provisioning, results show that the instantiation and removal of O-RAN applications does not interrupt network connectivity and service provisioning.
Reduction of OPEX and CAPEX as all procedures are automated and do not require any human intervention.
Integrated with Colosseum. Colosseum+OrchestRAN serve as a digital twin to train, test, and validate data-driven solutions for Open RAN and O-RAN systems prior to deployment over commercial networks.

### Example Uses

Usable in any Open RAN network, including those following O-RAN specifications. In particular, OrchestRAN allows telcos to express their intent, while the entire control logic is performed automatically in the background by the solutions described herein.
Can be used to select and deploy any ML/AI models for cellular applications via containers or other software components that are not necessarily following O-RAN specifications.
Orchestrating network intelligence in Open RAN based cellular systems.
Cloud-based service provisioning where there is a need to orchestrate network intelligence via automated deployment of software components.
   Distributed Applications for Real-Time Inference and Control in O-RAN (“dAPPS”)

The Open Radio Access Network (Open RAN)—being standardized, among others, by the O-RAN Alliance and the Telecom Infra Project (TIP)—brings a radical transformation to the cellular ecosystem through disaggregation and RAN Intelligent Controllers (RICs) notions. The latter enable closed-loop control through custom logic applications, e.g., xApps and rApps, supporting control decisions at different timescales. However, the current O-RAN and other Open RAN specifications lack of a practical approach to execute real-time control loops operating at timescales below 10 ms.

As previously noted, cellular networks are undergoing a radical paradigm shift. One of the major drivers is the Open Radio Access Network (Open RAN) paradigm, which brings together concepts such as softwarization, disaggregation, open interfaces, and “white-box” programmable hardware to supplant traditionally closed and inflexible architectures, thus laying the foundations for more agile, multi-vendor, data-driven, and optimized cellular networks. This revolution is primarily led by the O-RAN Alliance, a consortium of network operators, vendors, and academic partners. O-RAN is standardizing the Open RAN architecture, its components and their functionalities, as well as open interfaces to facilitate interoperability between multi-vendor components, real-time monitoring of the RAN, data collection and interactions with the cloud. By adopting the 7.2× split, O-RAN builds upon the disaggregated 3GPP Next Generation Node Bases (gNBs), that divides the functionalities of the base stations across Central Units (CUs), Distributed Units (DUs), and Radio Units (RUs). However, while O-RAN is a clear leader in standardizing the Open RAN architecture, it should also be noted that other organizations such as, for example, the Telecom Infra Project (TIP), are also working in this area. It will furthermore be apparent in view of this disclosure that, although O-RAN nomenclature is used throughout for convenience, the dApps provided herein can be used in connection with any Open RAN architecture in accordance with various embodiments.

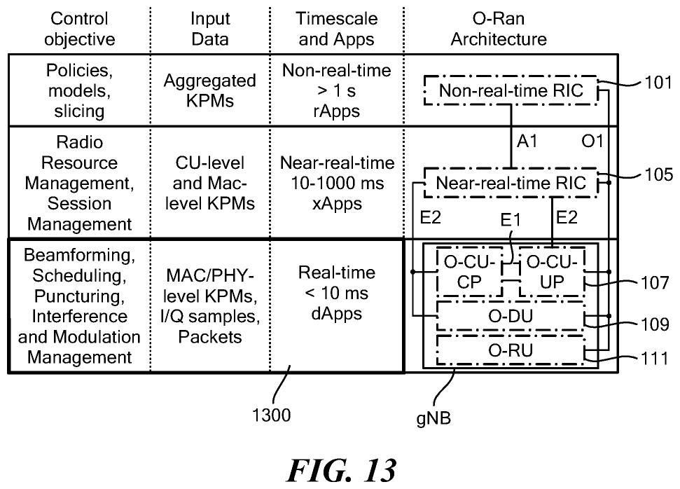

As shown in FIG. 13, O-RAN also introduces the concept of the RAN Intelligent Controller (RIC), an abstraction that enables near-real-time (or near-RT) and non-real-time (non-RT) control and monitoring of the RAN via software applications called xApps and rApps, respectively. In the O-RAN vision, the components of the RAN expose a set of controllable parameters and functionalities, as well as streams of data (e.g., Key Performance Measurements (KPMs)). These are used by xApps and rApps to fine-tune the behavior of the RAN, adapting it to the operator goals, and to the network and traffic conditions through sophisticated Artificial Intelligence (AI) and Machine Learning (ML) algorithms. The RICs, xApps and rApps will eventually realize the vision of self-organizing networks autonomously detecting ongoing changes in channel, network, and traffic state, and reacting to meet minimum Quality of Service (QOS) requirements and to comply with Service Level Agreements (SLAs). This includes resource allocation, network slicing, handover and mobility management, and spectrum coexistence.

However, cellular networks are still far from the vision of fully automated and intelligent cellular networks. Indeed, limiting the execution of control applications to the near-RT and non-RT RICs prevents the use of data-driven solutions where control decisions and inference must be made in real time, or within temporal windows shorter than the 10 ms supported by near-RT control loops. Two practical examples are user scheduling and beam management. Scheduling requires making decisions at sub-ms timescales (e.g., to perform puncturing and preemption to support Ultra Reliable and Low Latency Communications (URLLC) traffic with latency values as low as 1 ms). Similarly, beam management involves beam sweeping via reference signals transmitted within 5 ms-long bursts (half the duration of a 5G NR frame).

Unfortunately, the near-RT RIC and xApps might struggle in accomplishing these procedures because they have limited access to low-level information (e.g., transmissions queues, I/Q samples, beam directionality) and/or incur high latency to obtain it. For example, beam management would require the transmission of reference signals (or, as proposed in, I/Q samples) from the DU/RU to the RIC over the E2 interface. This would result in increased overhead and delay due to propagation, transmission, switching, and inference latency, which might prevent real-time (i.e., <10 ms) execution. Moreover, since I/Q samples contain sensitive user data (e.g., packet payload), they cannot be transmitted to the RIC out of privacy and security concerns and are therefore processed at the gNB directly. For these reasons, such procedures (and any procedure that requires real-time execution, or handles sensible data) are typically run directly at the DU/RU, usually via closed and proprietary implementations—referred to as the “vendor's secret sauce”. While hardware-based implementations can satisfy the above temporal requirements and deliver high performance, they are ultimately inflexible, hard to update, and not scalable as their upgrade (e.g., after a new 3GPP release) requires hardware or (whenever possible) firmware updates.

As of today, the O-RAN architecture focuses on offering softwarized, programmatic and AI-based control to the higher layers of the protocol stack, with limited flexibility for the lower layers hosted at DUs/RUs. However, prior work has demonstrated how running AI at the edge of the network—with a specific focus on PHY and MAC layers of the DUs/RUs—can provide major performance benefits. Moreover, recent works have shown that AI at the edge can significantly improve network performance by leveraging traditionally available KPMs (e.g., throughput, Signal to Interference plus Noise Ratio (SINR), channel quality information, latency), as well as by processing in parallel (thus not affecting demodulation and decoding procedures) I/Q samples collected at the PHY layer that carry detailed information on channel conditions and spatial information of received waveforms. Although the O-RAN specifications have identified a few use cases that could benefit from running intelligence at gNBs directly, these use cases are left for future studies.

Described herein are systems and methods for enabling network intelligence at the edge in the O-RAN ecosystem. As illustrated in FIG. 13, the notion of dApps is described. dApps are custom and distributed applications that complement xApps/rApps by implementing RAN intelligence at the CUs/DUs for real-time use cases outside the timescales of the current RICs. dApps receive real-time data and KPMs from the RUs (e.g., frequency-domain I/Q samples), DUs (e.g., buffer size, QoS levels), and CUs (e.g., mobility, radio link state), as well as Enrichment Information (EI) from the near-RT RIC, and use it to execute real-time inference and control of lower-layer functionalities. dApps build on already available logical components and propose an extension of the O-RAN architecture to include the concept of dApps with minimal modification to the specifications. Finally, challenges specific to dApps are discussed, and preliminary experimental results obtained on the Colosseum testbed are provided that demonstrate how dApps can enable a variety of real-time inference tasks at the edge and reduce control overhead.

Advantages of dAPPS

dApps are distributed applications that complement xApps/rApps to bring intelligence at CUs/DUs and support real-time inference at tighter timescales than those of the RICs. This section identifies their advantages and discusses relevant use cases and applications.

Reduced Latency and Overhead. Moving functionalities and services to the edge is one of the most efficient ways to reduce latency. The near-RT RIC brings network control closer to the edge, but it primarily executes in cloud facilities. Therefore, data still needs to travel from the DUs to the near-RT RIC, and the output of the inference needs to go back to the DUs/RUs, which causes increased latency and overhead over the E2 interface to support data collection, inference and control. This can be mitigated by executing real-time procedures at the CUs/DUs directly via dApps, which substantially reduces both latency and overhead (e.g., below a 3.57× overhead reduction is demonstrated below).

AI at the Edge. While AI (and specifically ML) is usually associated with data centers with hundreds of GPUs, nowadays there is plenty of evidence on the feasibility of training and executing AI on resource-constrained edge nodes with a limited footprint. GPUs are now smaller, more powerful, cheaper, and widely available. Technological advances in AI have resulted in procedures and techniques (e.g., pruning) that make it possible to compress ML-solutions by 27× and reduce inference times by 17× while resulting in a negligible accuracy loss of 1%.

Controlling MAC- and PHY-layer Functionalities. Another important aspect is related to controlling lower-layer functionalities of the MAC and PHY layers, such as procedures related to scheduling, modulation, coding and beamforming, which all operate at sub-ms timescales and require real-time execution. While xApps can be used to select which scheduling policy to use at the DU (e.g., round-robin), they cannot allocate resource elements to User Equipment (UEs) in real time at the sub-frame level (e.g., to perform puncturing and preemption for URLLC traffic). Moreover, many PHY-layer functionalities (e.g., beamforming, modulation recognition, channel equalization, radio-frequency fingerprinting-based authentication) operate in the I/Q domain and recent advances show how those can be executed in software with increased flexibility, reduced complexity, and higher scalability by processing the I/Q samples directly. Because of these tight time constraints and security concerns, xApps and rApps—which operate far from the DUs—unlike dApps, are not suitable to make decisions on these functionalities.

Access DU/CU Data and Functionalities in Real Time. dApps make it possible to access control- and user-plane data that is either unavailable at the near-RT RIC, or available but not with a sub-ms latency. This includes real-time access to I/Q samples, data packets, handover-related mobility information, dual-connectivity between 5G NR and 4G, among others. By executing at the DUs/CUs, dApps will be able to access UE-specific metrics and data to deliver higher performance services tailored to individual UE requirements, and instantaneous channel and network conditions.

Extensibility and Reconfigurability. Although there are rare cases where AI has been already embedded into DUs and CUs the majority of such solutions still leverage hardware-based implementations of MAC and PHY functionalities that strongly limit their extensibility and reprogrammability. On the contrary, the integration of dApps within the O-RAN ecosystem offers the ideal platform for software-based implementations of the above functionalities, and thus facilitates their instantiation, execution and reconfiguration in real time and on demand. In this context, the O-RAN Alliance is developing standardized interfaces to support hardware acceleration in O-RAN, which is a first step toward the integration of AI within DUs and RUs.

### Challenges and Open Issues

Despite the above advantages, bringing intelligence to the edge comes with several challenges:

Resource management. First, AI solutions require computational capabilities to quickly and reliably perform inference. For this reason, the DUs must be equipped with enough computational power to support the execution of several concurrent dApps sharing the same physical resources without incurring in resource starvation and/or increased latency due to the instantiation and execution of many dApps on the same node. In this context, GPUs, CPUs, FPGAs, hardware acceleration and efficient resource virtualization, sharing and allocation schemes will play a vital role in the success of dApps.

Softwarized ecosystem. Similar to the RIC, CUs/DUs, in an O-RAN architecture will need a container-based platform to support the seamless instantiation, execution, and lifecycle management of dApps. In contrast with other virtualization solutions (e.g., virtual machines), this offers a balanced tradeoff between platform-independent deployment, portable and lightweight development and rapid instantiation and execution. At the same time, dApps must not halt or delay the real-time execution of gNB functionalities. In this context, hardware acceleration will be pivotal in guaranteeing that dApps execute reliably and fast.

Standardized interfaces for DUs/CUs. The execution of intelligence at the edge requires interfaces between DUs, CUs, and dApps that offer similar functionalities to those currently available to the RICs and other O-RAN components. This includes northbound between dApps and the near-RT RIC) and southbound (between dApps and programmable functionalities and parameters of DUs/CUs) interfaces. In this way, DUs can expose supported control and data collection capabilities to CUs and the near-RT RIC. This is key to make sure that dApps are platform-independent and can seamlessly interact with other O-RAN components and applications.

Orchestration of the intelligence. dApps come with additional diversity and complexity. This calls for orchestration solutions that can determine which control and inference tasks are executed via dApps at CUs/DUs, and which at the near-RT RIC via xApps according to data availability, control timescales, geographical requirements and network workload, while satisfying operator intents and SLAs. This also includes distributing network intelligence while avoiding conflicts between multiple O-RAN applications controlling RAN components. Dataset availability. The reliability and robustness of AI for real-time inference and control will heavily rely upon availability of diverse and heterogeneous datasets. Largescale Open RAN testbeds such as Colosseum and digital twins will play a relevant role in generating those datasets and train, test and validate the effectiveness and generalization capabilities of dApps.

Friction from vendors. Traditionally, gNB components host a large part of vendor's intellectual property (e.g., schedulers, beamforming, queue management). Enabling third-party applications at DUs and CUs will inevitably reduce the value of such intellectual property. Although the introduction of dApps may foster competitiveness and innovation, it might inevitably find friction from vendors. Another concern is often related to the monolithic development approach of RAN vendors, which would prevent the execution of third-party components such as dApps. Nonetheless, the xApp paradigm has already shown that it is possible to separate the RAN state machine between gNB nodes and the RICs for control in the near- or non-real-time timescales. However, it should be noted that these two aspects are not road blockers. Indeed, these have been already overcome in the historically closed market of networking solutions for data centers where, despite early frictions from manufacturers, Software Defined Networking (SDN) architectures and related solutions (e.g., P4, OpenFlow, Intel Tofino, to name a few) have taken over the market and demonstrated how real-time reprogrammability and open hardware are not only possible but extremely effective. This shows that monolithic, inflexible approaches are not the only option, and a similar approach to that of xApps/rApps can be adopted to implement dApps.

### Proposed Architecture

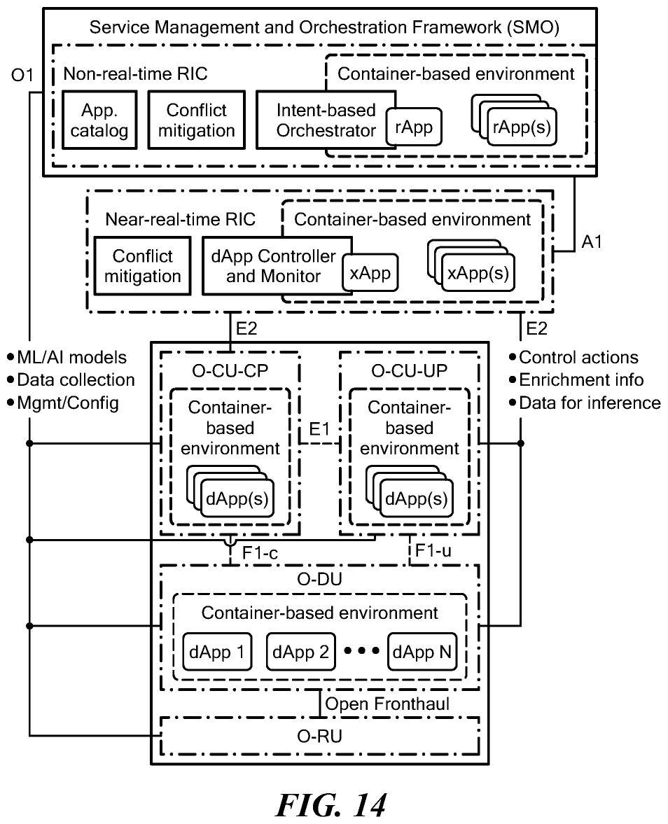

In this section, the architecture (shown in FIG. 14) for supporting dApps while requiring minimal changes to the already existing O-RAN architecture is described.

A. dApps as Softwarized Containers

Similarly to xApps and rApps, dApps leverage a containerized architecture to: (i) seamlessly manage the lifecycle of dApps, i.e., deployment, execution and termination; (ii) facilitate the integration and use of new (or updated) functionalities included in newly-released O-RAN specifications via software updates; (iii) provide an abstraction level where the CUS, DUs, and RUs advertise the tunable parameters and functionalities (similarly to what is already envisioned for xApps and the E2 interface) to enable dApps tailored to control specific parameters; (iv) achieve hardware-independent implementations of dApps, which can be offered as standalone O-RAN applications in a marketplace that fosters innovation and competition via openness, and (v) facilitate the development and use of AI-based solutions for the lower layers of the protocol stack. This approach also requires a resource manager in place that allows containers to access and share the physical resources (e.g., CPUs, GPUs, memory) available in the RAN nodes.

### B. Leveraging O-RAN Interfaces

The O-RAN interfaces currently available can be extended and used to support the deployment, execution and management of dApps:

Southbound Interfaces. Currently, the O-RAN specifications do not envision data-driven control based on analysis and inference of user-plane data, including I/Q samples and data packets. These, however, can be the basis for several data-driven use cases, discussed below. To support these use cases, dApps require southbound interfaces to allow dApps executing at the DU to receive (i) waveform samples in the frequency domain from the RU over the O-RAN Fronthaul interface, as well as (ii) transport blocks, or Radio Link Control (RLC) packets that are already locally available at the DU. Similarly, southbound interfaces must allow dApps executing at the CU to perform inference on locally available data pertaining to Packet Data Convergence Protocol (PDCP) and Service Data Adaptation Protocol (SDAP). As of today, these southbound interfaces are not yet available, but such southbound interfaces can be implemented by adapting and extending the Service Models (SMS) defined for the E2 interface. In this way, dApps can extract relevant KPMs using the southbound E2-like SM KPM adapted to support dApps within a latency of 10 ms to support real-time execution.

Northbound Interfaces. Similar to how xApps receive EI from the non-RT RIC via the A1 interface, dApps can receive EI from the near-RT RIC via the E2 interface. In this case, xApps process data from one or more gNBs, and send EI to the dApps, which use it to make decisions on control operations. For example, a DU can receive traffic forecasts from the near-RT RIC, and use this information to control scheduling, Modulation and Coding Scheme (MCS), and beamforming. Similarly to xApps, dApps are dispatched via the O1 interface.

C. Extending Conflict Mitigation to dApps

The O-RAN specifications envision conflict mitigation components to ensure that the same parameter or functionality (e.g., scheduling policy of a gNB) is controlled by at most one O-RAN application at any given time. The introduction of dApps will further emphasize the importance of conflict detection and mitigation at stricter timescales than those currently envisioned by O-RAN. Indeed, dApps require conflict mitigation to identify conflicts between rApps, xApps and dApps. In this context, pre-action conflict resolution (such as those envisioned for the near-RT RIC) can prevent directly observable conflicts between different applications (e.g., two applications controlling the same parameter). On the contrary, those conflicts that cannot be observed directly, i.e., implicit conflicts where two or more applications control different parameters indirectly affecting the same set of KPMs, can be mitigated through post-action verification where conflicts are detected by observing the impact and extent that control actions taken by different O-RAN applications have on the same KPMs.

### D. Intent-Based O-RAN Apps Orchestrator

The abundance of O-RAN applications will require automated solutions capable of determining which applications should be executed and where. This task is left to the orchestration module shown in FIG. 14 residing in the non-RT RIC and executing either as an rApp, or as a standalone component within the Service Management and Orchestration (SMO) domain. This module converts goals and requirements of the operator (e.g., in YAML/XML/JSON format) into a set of O-RAN applications that constitute a fabric of intelligent modules embedding the necessary AI to meet the desired intent. Then, it dispatches them from the application catalog where they reside to the RAN location where they are executed, thus creating a complex ecosystem of applications that cooperate to achieve the operator intent. To achieve this, the orchestrator needs to understand the intent specified by the operator, and compute the optimal configuration and set of applications to instantiate and where. This is performed by ensuring that applications are executed only at network nodes: (i) where input data can be made available within the required timescale; (ii) that can actually control the required parameters and functionalities, and (iii) with enough physical resources (e.g., CPUs/GPUs/FPGAs) to support the required applications. For example, if an operator wants to perform real-time beam detection and traffic forecasting for a set of gNBs, the orchestrator needs to deploy a dApp that executes at the DU (where the I/Q samples are available through the Open Fronthaul interface) to perform beam detection, and an xApp at the near-RT RIC (that receives traffic-related KPMs from the CUs via the E2 interface) to perform traffic forecasting.

E. dApp Controller and Monitor

This component is hosted in the near-RT RIC, (FIG. 14) and is in charge of controlling and monitoring dApps executing at the gNBs. Specifically, it ensures that dApps meet the desired QoS levels and are in line with the operator intent. As a possible extension, this component can also convert an xApp into multiple atomic dApps dispatched and executed at the gNB components to provide a finer control of the RAN procedures. In this case, the dispatchment can be coordinated by the non-RT RIC, and performed via the O1 interface.

### Use Cases and Results

Below, relevant use cases that would benefit from dApps are described and preliminary results are presented that demonstrate how dApps can effectively reduce overhead over O-RAN interfaces while supporting AI solutions for real-time control of the RAN.

### A. Beam Management

dApps can be used to extend the beam management capabilities of NR gNBs. The 3GPP specifies a set of synchronization and reference signals to evaluate the quality of specific beams, and to allow the UE and the RAN to use intelligent algorithms that select the best combination of transmit and receive beams. These techniques, however, require a dedicated implementation on RAN components that vendors offer as a black box. In this case, xApps and rApps can only embed logic to control high-level parameters, e.g., select and deploy a codebook at the RU based on KPMs or coarse channel measurements. On the contrary, dApps can support custom beam management logic where the dApp itself selects the beams to use and/or explore, rather than xApps providing high-level policy guidance.

For example, DeepBeam is a beam management framework that leverages deep learning on the I/Q samples to infer the Angle of Arrival (AoA) and which beam is the transmitter using in a certain codebook. DeepBeam is thus an example of a data-driven algorithm that cannot be deployed at the RICs, as it requires access to user-plane I/Q samples for inference. This approach is an ideal candidate for deployment in a dApp, as it requires access to information that can be easily exposed by a DU in real time (i.e., the frequency domain waveform samples), but cannot be transferred to another component of the network without (i) violating control latency constraints, (ii) exposing sensitive user data; and (iii) increasing the traffic on the E2 or O1 interface excessively.

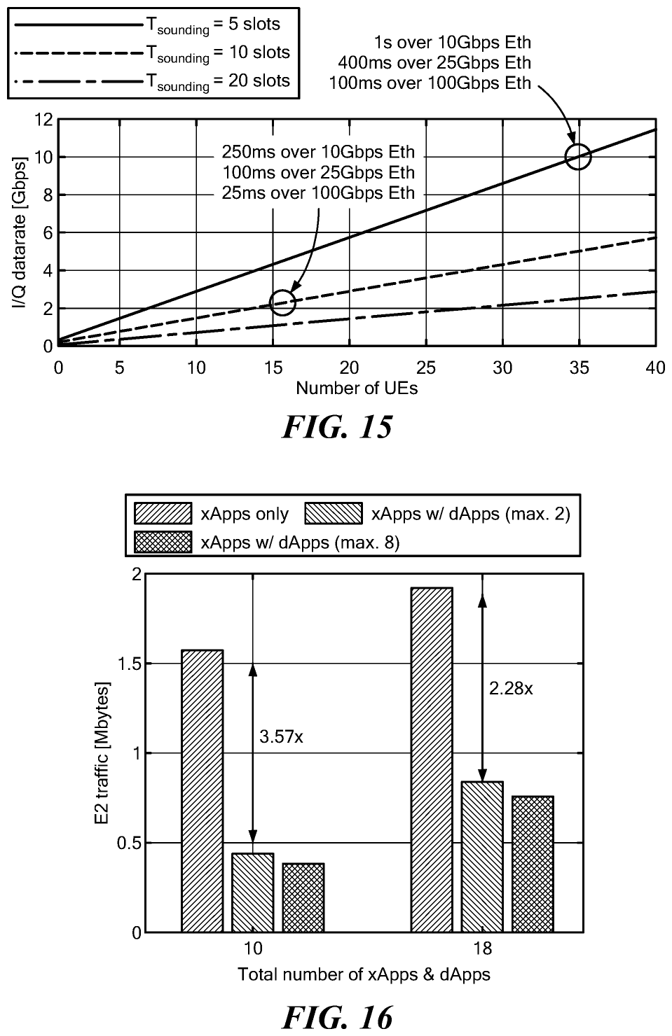

As an example, FIG. 15 reports the data rate (and time) needed to transfer the I/Q samples required to perform inference with the DeepBeam convolutional neural networks from a DU to the near-RT RIC. DeepBeam can perform inference and classify the transmit beam and AoA using any kind of samples (e.g., from packets or sounding signals). As a reference, in this case, consider the number of samples that can be collected through 3GPP NR Sounding Reference Signals (SRSs). 3GPP-based parameters are used and it is assumed that each SRS uses 3300 subcarriers (i.e., the full bandwidth available to NR UEs), 2 symbols in time, a periodicity τ_{sounding} of 5, 10, or 20 slots, and that each UE monitors 3 uplink beams. The I/Q samples have 9 bits, and numerology 3 (i.e., slots of 125 s) is assumed. The results show that it would be impractical to transfer the required amount of samples because of timing (i.e., no real-time control) and of the data rate required, which can reach more than 100 Gbps in certain configurations.

### B. Supporting Low-Latency Applications

Another application of practical relevance is that of dApps to support real-time and low-latency applications by, for example, controlling RAN slicing and scheduling decisions. Indeed, the timescale at which dApps operate is appropriate to access UE-specific information from the DU in real time (e.g., buffer size, MCS profile, instantaneous SINR), and to make decisions on the RAN slicing and resource allocation strategies based on QoS requirements and network conditions.

To showcase the benefits of dApps, a set of ML solutions for O-RAN applications was trained. Specifically, two Deep Reinforcement Learning (DRL) agents that process input data from the RAN (i.e., downlink buffer occupancy, throughput, traffic demand) were trained to control the scheduling and RAN slicing policies of the gNBs (training details are omitted for brevity and clarity). The gNBs are deployed on the Colosseum platform and implement network slices associated to different traffic types, i.e., Enhanced Mobile Broadband (eMBB), Machine-type Communications (MTC), and URLLC traffic. The agents aim at (i) maximizing the throughput for the eMBB slice, (ii) maximizing the number of transmitted packet for MTC, and (iii) reducing the service latency for URLLC. Moreover, two forecasting models were also trained to predict the UE traffic demand and the transmission buffer occupancy.

Consider the case where the DRL agents and the forecasters can run either at the near-RT RIC as xApps, or at the DUs as dApps. Both xApps and dApps have been implemented as Docker containers. In the former case, data for inference is received from the E2 interface, while in the latter data is locally available at the dApp. The OrchestRAN framework is also leveraged to orchestrate the network intelligence according to operator's intents, determine how to split and distribute intelligence among xApps and dApps, and dispatch them. FIG. 16 shows the impact that running intelligence at the dApps has on the overhead over the E2 interface as a function of the total number of deployed xApps and dApps. Consider three different configurations. In one configuration, the intelligence can only run at the xApps; in the other two, the ML solutions can be executed either through xApps or dApps, with the DUs supporting at most 2 and 8 concurrent dApps. FIG. 16 shows that dApps halve the traffic over the E2 interface, with a traffic reduction up to 3.57× with respect to the case with only xApps. Notice that two or more xApps can share the same input data received over the E2 interface. Thus, the traffic over E2 does not linearly grow with the number of xApps.

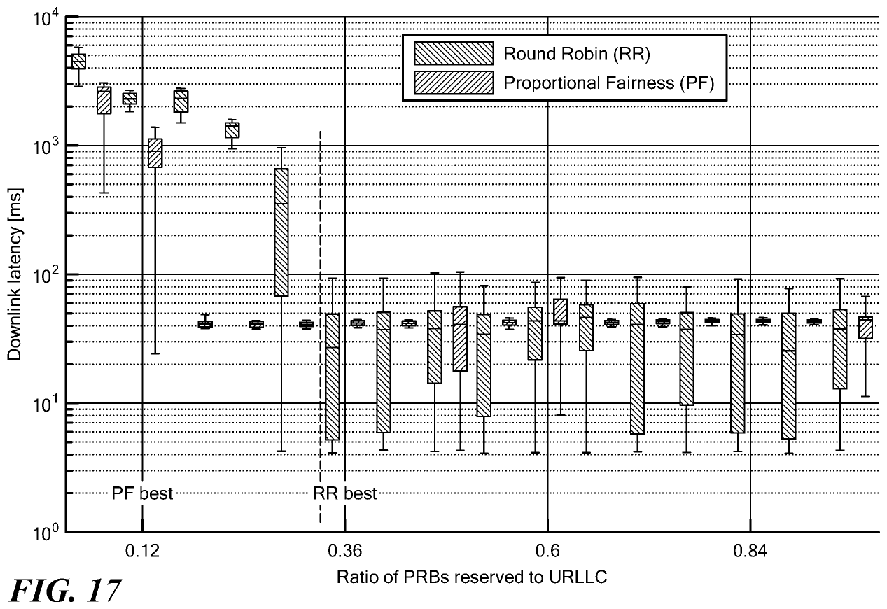

To further demonstrate the importance of controlling RAN behavior in real time, extensive data collection campaigns were run on Colosseum, and demonstrated the impact of selecting different RAN slicing (i.e., the ratio of Physical Resource Blocks (PRBs) reserved exclusively to URLLC traffic) and scheduling strategies (i.e., Round Robin (RR) and Proportional Fair (PF)) on the application-layer latency of URLLC traffic. The results reported in FIG. 17 demonstrate the importance of joint slicing and scheduling control to support URLLC use cases. For example, when less than 30% of resources are reserved for the URLLC traffic, selecting the PF scheduling algorithm ensures the lowest latency. On the contrary, RR works best when more PRBs are reserved to URLLC communications, with end-to-end latency values as low as 4 ms. These results show that achieving ultra-low latency still requires decisions made at the DUs directly via dApps to ensure a tolerable end-to-end latency level despite rapidly changing channel and network conditions (e.g., buffer size, traffic load).

In summary, the availability of data-driven, custom control logic is one of the major benefits of the O-RAN architecture. The technology described herein extends these benefits even further with the concept of dApp, distributed O-RAN applications executing at the DU and CU and complementing xApps and rApps. The benefits introduced by dApps include real-time control for a set of parameters that cannot otherwise be optimized with near-RT or non-RT control loops. Challenges generally relate to standardization, the need for resources and softwarized platforms, and orchestration of the functionalities. In addition, an architectural extension that enables dApps is provided and two relevant use cases are described. In general, dApps are well-suited to augment O-RAN control and monitoring operations subject to proper integration with data factories and digital twins for reliable AI, well-defined interfaces between dApps and CU/DU functionalities, and reduced frictions from vendors.

As used herein, “consisting essentially of” allows the inclusion of materials or steps that do not materially affect the basic and novel characteristics of the claim. Any recitation herein of the term “comprising,” particularly in a description of components of a composition or in a description of elements of a device, can be exchanged with “consisting essentially of” or “consisting of.”

To the extent that the appended claims have been drafted without multiple dependencies, this has been done only to accommodate formal requirements in jurisdictions that do not allow such multiple dependencies.

The present technology has been described in conjunction with certain preferred embodiments and aspects. It is to be understood that the technology is not limited to the exact details of construction, operation, exact materials or embodiments or aspects shown and described, and that various modifications, substitution of equivalents, alterations to the compositions, and other changes to the embodiments and aspects disclosed herein will be apparent to one of skill in the art.

What is claimed is:

1. A method for deployment and orchestration of network intelligence in an open radio access network (open RAN) comprising:
receiving a plurality of requests at a request collector of an orchestration app executable via a service management and orchestration (SMO) framework installed at a non-real-time (non-RT) RAN intelligent controller (RIC) of the Open RAN, each request specifying a requested functionality, a requested location, and a requested timescale;
selecting, by an orchestration engine, one or more pre-trained machine learning and/or artificial intelligence (ML/AI) models stored in a ML/AI catalog of the orchestration app, the selected ML/AI models applicable for satisfying the plurality of collected requests;
assigning at least one resource of the Open RAN to execute each of the applicable ML/AI models according to an orchestration policy determined by the orchestration engine, the Open RAN resources including at least one of the non-RT RIC, a near-real-time (near-RT) RIC, a centralized unit (CU), a distributed unit (DU), and a radio unit (RU);
automatically generating, by the orchestration engine, a plurality of executable software components, each executable software component embedding at least one of the ML/AI models and configured to be executed by the assigned one of the Open RAN resources;
dispatching each executable software component to the assigned one of the Open RAN resources; and
instantiating, at each of the assigned Open RAN resources, the at least one of the ML/AI models embedded within a corresponding one of the dispatched executable software components to configure the Open RAN to satisfy the requests.

2. The method of claim 1, wherein the steps of selecting and assigning are performed by an optimization core of the orchestration engine.

3. The method of claim 1, wherein the step of dispatching is performed by an instantiation and orchestration module of the orchestration engine.

4. The method of claim 1, wherein the step of automatically generating is performed by a container creation module of the orchestration engine.

5. The method of claim 1, wherein the executable software components include O-RAN docker containers comprising at least one of an rApp executable at the non-RT RIC, an xApp executable at the near-RT RIC, and a dApp executable at one or more of the CU, the DU, and the RU.

6. The method of claim 1, wherein the step of assigning further comprises accessing an infrastructure abstraction module of the orchestration app to determine a type and network location of the Open RAN resources.

7. The method of claim 1, wherein determining the orchestration policy further comprises solving a binary integer linear programming (BILP) orchestration problem.

8. The method of claim 7, wherein determining the orchestration policy further comprises reducing a complexity of the BILP orchestration problem by at least one of function-aware pruning, architecture-aware pruning, and graph tree branching.

9. A system for deployment and orchestration of network intelligence in an open radio access network (Open RAN) comprising:
an Open RAN having a plurality of Open RAN resources including at least one of a non-real-time (non-RT) RAN intelligent controller (RIC), a near-real-time (near-RT) RIC, a centralized unit (CU), a distributed unit (DU), and a radio unit (RU);
an orchestration app executable via a service management and orchestration (SMO) framework installed at the non-RT RIC, the orchestration app including:
a request collector configured to receive a plurality of requests, each request specifying a requested functionality, a requested location, and a requested timescale;
an orchestration engine configured to:
select one or more pre-trained machine learning and/or artificial intelligence (ML/AI) models stored in a ML/AI catalog of the orchestration app, the selected ML/AI models applicable for satisfying the plurality of collected requests,
assign, according to an orchestration policy determined by the orchestration engine, at least one of the Open RAN resources to execute each of the applicable ML/AI models,
generate a plurality of executable software components, each executable software component embedding at least one of the ML/AI models and configured to be executed by the assigned one of the Open RAN resources, and
dispatch each executable software component to the assigned one of the Open RAN resources; and
each of the assigned Open RAN resources configured to instantiate the at least one of the ML/AI models embedded within a corresponding one of the dispatched executable software components to configure the Open RAN to satisfy the requests.

10. The system of claim 9, wherein the orchestration engine further comprises an optimization core configured to select the ML/AI models and assign the Open RAN resources to execute the selected ML/AI models.

11. The system of claim 9, wherein the orchestration engine further comprises an instantiation and orchestration module configured to dispatch the executable software components.

12. The system of claim 9, wherein the orchestration engine further comprises a container creation module configured to generate the plurality of executable software components.

13. The system of claim 9, wherein the executable software components include O-RAN docker containers comprising at least one of an rApp executable at the non-RT RIC, an xApp executable at the near-RT RIC, and a dApp executable at one or more of the CU, the DU, and the RU.

14. The system of claim 13, wherein each dApp includes at least one RT-Transmission Time Interval (RT-TTI) level control loop.

15. The system of claim 14, wherein the RT-TTI level control loop of each dApp operates on a timescale of 10 ms or less.

16. The system of claim 9, wherein the orchestration app further comprises an infrastructure abstraction module accessible by the orchestration engine to determine a type and network location of the Open RAN resources.

17. The system of claim 9, wherein the orchestration policy is determined according to a solution of a binary integer linear programming (BILP) orchestration problem.

18. The system of claim 17, wherein the orchestration policy is further determined according to at least one preprocessing solution of at least one of function-aware pruning, architecture-aware pruning, and graph tree branching.
